(19) United States
(12) Patent Application Publication
(10) Pub. No.: US 2003/0221438 A1
(43) Pub. Date: Dec. 4, 2003

(54) Energy efficient sorption processes and systems

(76) Inventors: Milind V. Rane, Mumbai (IN); S. V. Kota Reddy, Andhra Pradesh (IN); Akhil Agarwal, Alwar (IN); Jaskaran S. Bajaj, Punjab (IN)

Correspondence Address: Raj S. Dave, Ph.D., J.D., Morrison & Foerster LLP, Suite 300, 1650 Tysons Boulevard, McLean, VA, 22102, US

(21) Appl. No.: 10/367,982

(22) Filed: Feb. 19, 2003

(30) Foreign Application Priority Data
Feb. 19, 2002 (IN) 151/MUM/2002
Feb. 19, 2002 (IN) 152/MUM/2002
Feb. 19, 2002 (IN) 153/MUM/2002
Feb. 19, 2002 (IN) 154/MUM/2002
Feb. 19, 2002 (IN) 155/MUM/2002
Aug. 23, 2002 (IN) 767/MUM/2002

(51) Int. Cl. F25B 37/00; F02M 23/14; F02M 31/00; F25D 23/00; F25B 25/00

(52) U.S. Cl. 62/271; 62/332; 261/140.2; 261/154

(57) ABSTRACT

The present invention relates to novel energy efficient sorption processes and systems for cooling, dehumidifying and heating using multistage liquid desiccant regenerators, or hybrid cooling systems or adsorption cooling systems involving appropriate combinations of rotating contacting devises, adsorption modules with heat transfer passages in thermal contact with the adsorption module wall and switchable heat pipes. The sorption processes of this invention help in flexible designing of compact cooling, dehumidifing, heating systems easy operability. The adsorption module of this invention leads to lower cycle times as low as 5 minutes; makes it possible to achieve high system Coefficient of Performance (COP) up to 0.9 due to reduced thermal mass; offers high specific cooling power in the range of 50 to 750 W/kg of AC; is easy to manufacture and operates at low costs. The refrigeration cum heating system of this invention with heat pipe in thermal contact with the adsorption modules increase the heat transfer rates without increasing the thermal mass leading to increase of COP and the single or multistage pressure equalisation increases the internal regeneration of heat thereby increasing the COP, reducing the cycle time resulting in increased specific cooling power (SCP), reducing the required quantity of adsorbent/refrigerant making the module compact and cost effective.

### RELATED APPLICATIONS

This application claim priority from Indian Provisional Application Serial Nos. (1) “Contacting Device,” 153/MUM/2002 filed on Feb. 19, 2002; (2) “Hybrid Cooling Systems,” 154/MUM/2002 filed on Feb. 19, 2002; (3) “Energy Efficient Regeneration,” 767/MUM/2002 filed on Aug. 23, 2002; (4) “Refrigeration cum Water Heating System,” 151/MUM/2002 filed on Feb. 19, 2002; (5) “Switchable Heat Pipe,” 152/MUM/2002 filed on Feb. 19, 2002; and (6) “Adsorption Module” 155/MUM/2002 filed on Feb. 19, 2002, the entire disclosures of which are hereby incorporated herein by reference.

### FIELD OF THE INVENTION

The present invention relates to novel energy efficient sorption processes and systems for cooling, dehumidifying and heating using multistage liquid desiccant regenerators, or hybrid cooling systems or adsorption cooling systems involving appropriate combinations of rotating contacting devise, adsorption module with heat transfer passages in thermal contact with the adsorption module wall and switchable heat pipes. The sorption processes of this invention lead to flexible designing of compact cooling, dehumidifing, heating systems easy operability.

### BACKGROUND ART

Equipment often employed for regeneration process of LD are packed bed regenerators, spray towers with finned tube heat exchangers, solar regenerator, simple boiler and multiple effect boiler. Processes requiring mass transfer between two contacting fluids often employ equipment such as spray towers, packed towers and tray towers. In spray towers and spray chambers the liquid is generally sprayed into a gas stream by some means to disperse the liquid into fine spray of drops. The flow may be counter current and co-current as in vertical towers, or parallel as in horizontal spray chambers. These devices have the advantage of low-pressure drop of the gas but may suffer from relatively high pumping cost for the liquid in spray. The tendency for carry over of liquid by the air/gas is considerable in the spray towers and mist eliminators will almost always be necessary leading to increase the air/gas side pressure drop. In conventional vapour compression refrigeration, system (VCRS) air is cooled below its dew point to reduce the moisture content, followed by reheating of the air to the desired temperatures prior to its introduction in the conditioned space. As the evaporator operates at lower temperature, the COP of the conventional VCRS is low.

Certain substances have the property of adsorbing some fluids at low temperatures and desorbing them at high temperatures. Adsorption Module is an apparatus, which facilitates the containment of the adsorbent and adsorbate and the process of its heating and cooling. These substances are selective in nature, i.e. they adsorb only specific fluids. This phenomenon can be used for separation of fluids. Alternatively, in sorption cooling applications these are used to adsorb refrigerants at low temperatures and pressure, and desorb them at high temperature and pressure.

The key problem in adsorption systems is low conductivity of the adsorbents and that of the adsorption bed, which in turn effects the cycle time of the system. An important aspect in the design of adsorption modules is to achieve higher heat transfer rates to and from the adsorption beds that results in low cycle time. To make the system compact number of cycles per unit time need to be increased resulting in reduced requirement of adsorbant and adsorbate. We now review the prior art relevant to the invention.

### BACKGROUND

Packed tower is used for regeneration process of LD (Martin, V. and Goswamy D. Y., Heat and Mass Transfer in Packed Bed Liquid Desiccant Regenerators—An Experimental Investigation, Journal of Solar Energy Engineering, Transactions of the ASME, Vol 121, pp163-169, USA, 1999). In this case the desiccant is distributed over the packing by spray heads and the process air was blown through the packing for regeneration of LD. The process air picks up the water from the LD because of the partial pressure difference of water in the process air and LD. The main problem associated in this regeneration process is carryover of LD along with air stream. Requirement of minimum irrigation rate and limitations of flooding in packed towers complicates the design or reduces the efficacy of the regeneration process. Also large power is required to circulate air/gas through packed bed.

Spray chamber with finned tube heat exchanger is the practical equipment for regeneration process of LD (Peng, C. S. P. and Howell R. J., The Performance of Various Types of Regenerators for Liquid Desiccants, Journal of Solar Energy Engineering, Transactions of the ASME, Vol 106, pp 133-141, USA, 1984). Finned tube heat exchangers are stacked horizontally with a column with hot water flowing in the tube side. LD was sprayed on the heat exchanger and drips down. A blower was used to circulate process air through the regenerator counter current to the falling LD. The advantage of the system is lower pressure drop for the air/gas side. However, there is a relatively high pumping cost for spraying the LD The tendency for carry over of liquid by the air/gas is considerable in the spray towers and mist eliminators will almost always be necessary leading to increase the air/gas side pressure drop. Even with mist eliminators 100% elimination of carryover is not ensured.

Regeneration of LD can be done using solar energy. Solar regenerator comprises inclined surface with transparent glazing as a covering where weak LD that is to be regenerated flows down the sloping surface as a falling film and is heated by the absorbed solar radiation (Peng, C. S. P. and Howell R J., The Performance of Various Types of Regenerators for Liquid Desiccants, Journal of Solar Energy Engineering, Transactions of the ASME, Vol 106, pp 133-141, USA, 1984). The water vapour that is evaporated from the solution surface is removed by blowing air through the slot formed between the glazing and the film surface. The disadvantage of the regeneration process is that the system is not operative during non-solar hours. There must be backup heat source for the regeneration of LD during non-solar hours.

The regeneration process of LD in a simple boiler can be achieved by heating the LD to boiling temperature (Lowenstein, A. I. and Dean, M. H., The Effect of Regenerator Performance on A Liquid Desiccant Air-Conditioner, ASHRAE Transactions: Symposia, Vol. 98, No.1, pp 704-711, USA, 1992). This regeneration process increases the energy required to preheat the weak desiccant that enters the regenerator. The higher the regeneration temperature higher is the regenerator corrosion rate. The regeneration process in a simple boiler is not energy efficient since the latent heat of the vapour generated is not recycled. Regeneration at sub atmospheric pressure can reduce the higher temperature of the simple desiccant boiler. Adding a vapour condenser to the boiler can do this. A non-condensable pump is required to maintain the vacuum in the regenerator. This increases the electrical power consumption.

In a double effect boiler, vapour from high-pressure boiler has a saturation temperature that is sufficient to provide required thermal input to lower pressure boiler. Low-pressure boiler is operating under vacuum. A non-condensable pump is required to maintain vacuum (Lowenstein, A. I. and Dean, M. H., The Effect of Regenerator Performance on A Liquid Desiccant Air-Conditioner, ASHRAE Transactions: Symposia, Vol. 98, No.1, pp 704-711, USA, 1992). Latent heat of vapour from high-pressure boiler is utilised in low-pressure boiler. However, maintaining vacuum in low-pressure boiler increases the electrical power consumption. Costly components are required for high-pressure boilers and an issue of safety becomes more complex.

U.S. Pat. No. 5,213,154, “Liquid Desiccant Regeneration System”, discloses a single stage regeneration system for use in air conditioning system. The system comprises of a direct-fired natural circulation boiler for regenerating LD. A falling film heat exchanger is used for transferring heat from concentrated desiccant to dilute desiccant. It is single stage regeneration process, the latent heat from the vapour leaving from the boiler is not recycled/reutilised. The single stage regeneration process is exergetically less efficient.

U.S. Pat. No. 4,939,906, “Multi-Stage Boiler/Regenerator for Liquid Desiccant Dehumidifier”, describe a regeneration process with a gas fired desiccant boiler and a combined desiccant regenerator/interchange heat exchanger for use in air-conditioning system. The regeneration process accomplished by diverting portion of LD flowing through a desiccant conditioner and heating the desiccant in an interchange heat exchanger, an air desiccant regenerator, a second interchange heat exchanger and a boiler. The latent heat of vapour generated in the boiler is delivered to the air in a heat exchanger. The weak desiccant is preheated in another heat exchanger using heated air, before entering the boiler. Two heat exchangers are used to deliver the latent heat of vapour to pre heat the LD, which is not energy efficient.

U.S. Pat. No. 5,097,668, “Energy Reuse Regenerator for Liquid Desiccant Air Conditioners”, discloses the regeneration process of LD in air-conditioners, which uses LD for dehumidification of air. The regeneration of LD is achieved in a desiccant boiler and a desiccant evaporator/condenser in combination with heat exchangers. The evaporator/condenser receive the vapour produced by the boiler to provide a reuse of heat for regeneration. Certain quantity of LD from air-conditioner is flowing to evaporator/condenser, where it is sprayed over the surface through which vapour from boiler is flowing. Certain quantity of LD from air-conditioner is directly flowing to boiler for regeneration. As the LD is sprayed in presence of air in the evaporator/condenser carryover of LD with the air stream is inevitable. Additional electrical power is required for spraying LD in the evaporator/condenser.

U.S. Pat. No. 4,189,848 “Energy Efficient Regenerative Liquid Desiccant Drying Process”, discloses a method and apparatus for the drying of harvested crops by utilising desiccants with a closed loop drying loop and open drying loop. In the closed drying loop cycle the drying air brought in to contact with a desiccant in a packed tower after it exits from a crop-drying bin. During the open loop drying cycle the used desiccant is heated and regenerated at high temperature driving water vapour from the desiccant. The water vapour condensed was used to pre heat the dilute desiccant before heat is added from the external source in the regenerator. As the regeneration and absorption processes are taking place in the packed towers the carryover of LD in to the air stream is inevitable. Large electrical power is required to circulate the air through packed towers.

U.S. Pat. No. 4,941,324, “Hybrid Vapour Compression/Liquid Desiccant Air Conditioner”, discloses a hybrid air-conditioning system consisting of a compressor, evaporator, condenser and refrigerant. LD and refrigerant are simultaneously circulated between evaporator and condenser for cooling and dehumidifying air forced therein. The regeneration of the LD is achieved by spraying the LD on the condenser of vapour compression refrigeration system. A blower is provided to circulate the outdoor air to regenerate the LD. The main problem with such arrangement is corrosion of the condenser coil. Moreover as the LD is sprayed, carryover and loss of LD to indoor and out door air streams is inevitable.

U.S. Pat. No. 4,180,985, “Air-conditioning System with Regeneratable Desiccant Bed” discloses the regeneration process using a desiccant pad material such as fibreglass pads, wire screens and packed steel shavings. The desiccant pad is disposed and supported within the feed duct. Condenser coil of vapour compression refrigeration system is disposed within the regenerator duct. The air is directed across the condenser coil by mean a fan. Liquid desiccant is sprayed in presence of hot air stream across the desiccant pad, which provides large surface area between desiccant and air. In this process carryover of LD to air stream is inevitable. In spite of use of mist eliminators carryover of LD is inevitable.

U.S. Pat. No. 4,259,849, “Chemical Dehumidification System Which Utilises A Refrigeration Unit for Supplying Energy to the System”, discloses a sorbent type air-conditioning system which employs refrigeration unit, including a compressor, evaporator, condenser and refrigerant. The regeneration of LD is achieved in a packed tower with spray nozzles. Corrugated sheet material impregnated with a thermosetting resin is the packing material, through which LD trickles by gravity. Large pressure drops across the packing material. Carryover of LD with air stream is not addressed.

Packing in packed towers provide large interfacial surface between liquid and air/gas. The key requirements of the packing are large surface area per unit volume and must permit large volume flow of fluids through small tower cross section with lower pressure drop for the air/gas. Packings in the form of Ranching rings, Lessing ring, Partition ring, BerI saddle and Pall rings are commonly used in packed columns (Robert, E. Treybal, Mass—Transfer Operations, pp 187-191, Mcgraw-Hill Book Company, 1981). Random packings offer large specific surface but suffer from larger air/gas side pressure drop. Regular or stacked packings like Ranching rings, Double spiral ring, Wood grids offer lower pressure drop than random packings for the air/gas side. Generally absorbers with regular packings are designed for air/gas side pressure drop of 200 to 400 Pa per m of packed depth (Robert, E. Treybal, Mass—Transfer Operations, pp 187-191, Mcgraw-Hill Book Company, 1981). Regular packings are costlier than random packings polypropylene Rauschert Hiflow rings of size 2.54 cm offer a surface density of about 210 m²/m³ (Oberg, V. and Goswamy D. Y., Experimental study of the heat and mass transfer in a packed bed liquid desiccant air dehumidifier, Journal of Solar Energy Engineering, Transactions of the ASME, Vol 120, pp 289-297, USA, 1998). Such equipments need well-designed tower shells, packing supports, liquid distributors, packing restrainers, entrainment eliminators etc., which make them fairly expensive. Minimum irrigation rate and flooding in packed towers complicates the design or reduces the efficacy of the process. Large power is required to circulate air/gas through packed bed.

The long felt need in this field has been to innovate contacting devices that are techno-economically viable and provide for the essential functional features so as to:

a. incorporate large heat and mass transfer area between vapour/gas stream and liquid

b. ensure no carryover of liquid in to the vapour/gas stream

c. have the provision to heat/cool the liquid depending on the application

d. extending the limits on the minimum irrigation rate and flooding

U.S. Pat. No. 4,333,894, loses mass transfer column consisting of one or more contact zones. The contact zones are exclusively provided with packings placed in prearranged locations. In the contact zones, optimal operating conditions for the packing are created over the entire height of the contact zones in order to achieve a minimal pressure loss at a concomitant high separating efficiency. This is done by a suitable gradated adaptability of the packing to vapour and liquid loads varying over the height of the contact zones. It was claimed uniform flow of liquid through the bed. However, this patent does not address the issue of carry over of liquid along with air/gas.

U.S. Pat. No. 5,679,290, describes an improved packed tower for effecting the adsorption of a gas into a liquid, comprising a cylindrical tower wall defining a packing zone; a plurality of packing pieces contained within a packing zone; a liquid distributor above the packing zone for distributing liquid on to the packing pieces; a gas feeding inlet below the packing pieces for feeding gas through the packing zone. The improvement claimed in this patent is in the plurality of packing pieces and the packing of different sizes in two zones. First packing zone is an annulus adjacent at an upper part of the tower wall. Rest of the tower acts as the second zone. First packing pieces are smaller than the second plurality of packing pieces. Surface area of the packing is 119 m²/m³ with 2×2×4 inch ceramic saddles in the first zone. In the second zone the packing is also ceramic saddled of size 3×3×6 inch which were giving a surface area of 93 m²/m³. In this patent too the carryover of liquid along with air/gas stream is not addressed.

In U.S. Pat. No. 5,882,772 and 6007915, packing materials to increase the surface area, in packed bed towers are reported but do not comprehensively resolve all the issues as required.

Contacting discs have been used in evaporatively cooled condenser for vapour compression refrigeration system (Yunho, Hwang, Reinhard Radermacher and William Kopko, “An Experimetal Evaluation of A Residential Sized Evaporatively Cooled Condenser”, International Journal of Refrigeration, 24, pp 238-249, 2001). Plastic discs of 2 feet diameter are used as contacting device between ambient air and water used for condensing the refrigerant. However, the prior art does not teach any of the aspects of the wetting of the discs by water, their optimal sizes, etc.

In the development of vapour absorption heat pump, contacting discs have also been used in mixed alkali hydroxides to absorb water vapour (Shallow, F. E. and Smith, I. E., “Vapour Absorption Into Liquid Film on Rotating Discs” Proceeding of the Work Shop on Absorption Heat Pumps, London, pp 373-381, 1988). Copper discs of 110 mm diameter were rotated at the speed of 200 rpm in vacuum chamber. There is no specific teaching about spacing between the discs and wetting of the surface of the discs with liquid.

The rotary evaporative cooler with rotary vertical wheel shaped saturating pads 127 mm thick and 660 mm to 1370 mm diameter, composed of spirally wound layers of alternatively flat or crimped bronze screen wires have been losed in the article by (John, R. Watt, Evaporative Air Conditioning hand Book, pp 115-161, Chapman and Hall, New York, 1986). This device does address the issue of proper wetting of the pad without splashing or blowing, at rotating speeds of around 2 rpm, but the cost of the rotor is high.

Desiccants are a subset of a group of materials called sorbents. Desiccants in particular have high affinity for water and their absorption capacity varies with the structural characteristics of the material. For example, nylon can absorb up to 6 percent of its weight of water, wood can absorb 23 percent of its weight, whereas a commercially available desiccant can hold about 1100 percent of its weight of water. Some examples of such desiccants are Lithium chloride, Lithium bromide, etc. (ASHRAE, “Fundamentals Handbook”, American Society for Heating Refrigeration and Air-conditioning Engineers, pp 21.1-21.5, Atlanta, USA, 1997).

The desiccant affinity to absorb the moisture can be regenerated repeatedly by applying heat to the desiccant material to drive off collected moisture. Low-grade heat can be obtained from a variety of sources such as solar collector, radiator hot water, engine exhaust, condenser heat recovery from refrigeration machines, burning bio mass, etc. The temperature for this process is generally in the range of 50° C. to 260° C. depending on the material.

Desiccant cooling systems (DCS) are energy efficient and environmentally safe. In recent years, DCS have received considerable attention due to their inherent ability to use low-grade thermal energy and reduce the latent cooling load significantly. Desiccant dehumidification can reduce total electricity demand by as much as 25% in humid regions. These systems provide a drier, more comfortable and cleaner indoor environment with lower consumption of electric power.

In liquid desiccant (LD) dehumidification systems air is dehumidified when exposed to hygroscopic solutions. At a given temperature the desiccant has a lower vapour pressure than pure water, and hence moisture transfer takes place from-air to solution. Several desiccants such as Triethylene glycol, Lithium chloride, Lithium bromide, Calcium chloride etc. are extensively in use. Some desiccants also have the ability of simultaneously controlling microbiological contaminants from air streams to improve the quality of air (ASHRAE, “Fundamentals Handbook”, American Society for Heating Refrigeration and Air-conditioning Engineers, pp 21.1-21.5, Atlanta, USA, 1997). It may also be noted that as the process air is not allowed to reach the saturation condition at any point in the desiccant cycle it prohibits the growth of moulds, fungi, or other microbial organisms in air conditioners (Lowenstein, A. I. and Dean, M. H., “The Effect of Regenerator Performance on A Liquid Desiccant Air-Conditioner”, ASHRAE Transactions: Symposia, Vol. 98, No.1, pp 704-711, USA. 1992).

Similar to conventional DCS, most of HCS have two air streams, one is the processed air delivered to conditioned space, the other stream is used to regenerate liquid desiccant. Howell and Peterson, 1986 have studied a hybrid system combining liquid desiccant dehumidification with VCRS (Howell, J. R. and Peterson, J. C., “Preliminary Performance Evaluation of A Hybrid Vapour Compression/Liquid Desiccant Air-Conditioning System”, ASME, paper 86-WA/sol.9, Anaheim, Calif., USA., December 1986). It was found that the hybrid system reduces area of evaporation and condensation by 34%, and power consumption by 25%, compared with VCRS alone. Study on a gas fired air conditioning system combining vapour compression machine with solid desiccant dehumidifier, it is reported that cooling capacity of hybrid system increased by 50% and the COP increased by 40%. However, the initial cost increased to US$ 140 per kW cooling capacity (Parson, B. K., Pesaran, A. A., Bharathan, D. and Shelpuk, B. “Improving Gas Fired Heat Pump Capacity and Performance by Adding A Desiccant Dehumidification Subsystem”, ASHRAE Transactions, Vol 95, pp 835-844, USA. 1989).

Hybrid vapour compression/liquid desiccant air conditioner has been described in U.S. Pat. No. 4,941,324. In this approach, the LD is sprayed on the evaporator of the vapour compression refrigeration system for cooling and dehumidification of air. The regeneration of the LD is achieved by spraying the LD on the condenser of vapour compression refrigeration system. Two blowers were provided to circulate the indoor air over the cooling coil and out door air to regenerate the LD. An adiabatic humidifier is provided in the cycle. The main problem with such arrangement is corrosion of the condenser and evaporator coils. Moreover as the LD is sprayed, carryover of LD to indoor and out door air streams is inevitable.

U.S. Pat. No. 5,022,241 discloses a residential type hybrid air conditioning system, having a conventional absorption refrigeration subsystem to handle the sensible heat loads and a LD subsystem to handle the system latent load. This system incorporates an evaporative cooler for cooling and re-humidification of the process air. In this case too the carry over of LD with the process air is unavoidable as the desiccant is sprayed in the system.

U.S. Pat. No. 4,180,985 discloses an air-conditioning system with a regeneratable desiccant bed. This arrangement employs a desiccant pad of any suitable material that can be disposed and supported within the feed duct to allow the moist feed air to flow through the pad and contact the LD material. Materials such as fiber glass pads, wire screens, packed steel shavings have been used. In this patent problems due to the carryover of LD with air stream are not addressed

U.S. Pat. No. 4,887,438 describes a desiccant assisted air conditioning system with silica gel. Regeneration temperature was around 98° C. It is reported that energy saving can be 10 to 15% and reheating after refrigeration is eliminated. As the regeneration temperature is high, the coefficient of performance (COP) of this VCRS is low.

Applicants recognised that it desirable to have adsorption modules that exhibit the following characteristics:

a. High thermal conductivity of the adsorbent bed

b. High rates of heat transfer to and from the bed

c. Low thermal mass of the adsorption module

d. Low thermal mass of adsorbent module while having high rates of heat transfer

e. High affinity for adsorbate per unit quantity of adsorbent.

Past, attempts to achieve the above objectives have been any of the following four approaches:

a. Use of binders and additives (e.g. graphite) with good thermal conductivity or metallic foam, which are well bound with adsorbent powder: U.S. Pat. No. 4,138,850 uses a solid zeolite adsorbent mixed with a binder, pressed, and sintered into divider panels and hermetically sealed in containers. Such systems are prone to loosing the contact between the adsorbent and the heat transfer surface as the system is cycled repeatedly leading to reduced thermal conductivity over a period of time and thereby reducing its specific cooling power. This increases the cost of the system.

b. Use of consolidated samples (like bricks): U.S. Pat. No. 4,637,218 uses zeolites that are sliced into bricks or pressed into a desired configuration. However, the fabrication of this type of module is complex.

c. Use of compartmentalized reactors: U.S. Pat. No. 5,477,705 discloses an apparatus for refrigeration employing a compartmentalized reactor. As the entire heat transfer surface area is not active at any given time, the total surface area required in the system is much larger, thereby adding to the thermal mass, which in turn necessitates more heat to be transferred to achieve the required COP. This increases the size, weight and cost of the system.

d. Use of metallic fins or coating metal tubes with the adsorbent: U.S. Pat. No. 4,548,046 relates to an apparatus for cooling or heating by adsorption of a refrigerating fluid on a solid adsorbent. The operation employs a plurality of tubes provided with radial fins, the spaces between which are filled or covered with solid adsorbent such as zeolite 13X located on outside of the tubes.

U.S. Pat. No. 6,102,107 relates to a sorption cooling module employing a uniform adsorbent coating on a fin plate surface which does not build up on heat transfer medium tubes passing through the fin plates even in a dense plate configuration. The large number of small diameter tubes complicates the fabrication of such a system. The increased number of tubes and the joints enhances the possibility of leakage.

U.S. Pat. No. 5,518,977 relates to sorption cooling device, which employ adsorbent-coated surfaces to obtain a high cooling coefficient of performance. Thermal mass of the surface which is coated adds to the thermal mass, which leads to reduced COP. Also, with time the adsorbent coating might get dislodge due to cycling and/or thermal shocks.

In a review paper titled “Solar adsorption technologies for ice-making and air-conditioning purposes and recent developments in solar technology” by Wang and Dieng (“Literature review on solar adsorption technologies for ice-making and air-conditioning purposes and recent developments in solar technology”, Renewable & Sustainable Energy Reviews, Vol. 5, pp. 313-342, 2001) conclude that some crucial points in the development of sorption systems still exists especially those related to problems of low specific cooling power of the machine and high investment costs. It also mentions that thermosyphons and heat pipes are one of the most convenient heat transfer devices for the solid and liquid sorption machines due to their flexibility, high thermal efficiency, cost-effectiveness and reliability.

However the thermosyphones and heat pipes disclosed in the prior art suffer from low heat transfer rates when used without fins and increase in thermal mass when used with fins. Heat pipes are defined as systems employing closed evaporating-condensing cycles for transporting heat from a location of heat generation to a location of heat reception capable of transporting large amount of heat with small temperature gradient. They are configured in various shapes and geometry and may optionally use a capillary structure or wick to facilitate return of the condensate. A heat pipe may be represented by a tube with both ends sealed and partially filled with liquid, one end of which is capable of acting as an evaporator and the other end acting as the condenser. Such heat pipes can continuously transfer heat from the hot end to cold end. A heat pipe capable of controlling the heat transfer is known as switchable heat pipe.

Switchable heat pipes as effective heat transport devices have been developed for a variety of applications in space technology, refrigeration, air-conditioning, electronic cooling, etc. Prior art is based on two approaches:

a. To isolate the condenser and evaporator using various types of valves which are externally operated. Ways of implementing them are disclosed in U.S. Pat. No. 6,167,955 and U.S. Pat. No. 6,047,766.

b. A common manner to achieve switchable heat pipes is to prevent the condensate from flowing back to the evaporator. In this case the evaporator gradually dries out and the heat transfer seizes to take place. Various way of implementing such a process is disclosed in U.S. Pat. Nos. 5,159,972, 5,771,967, 4974667, 4026348 and 4437510.

In these patents, the switching mechanisms are implemented as follows:

In U.S. Pat. Nos. 5,159,972 & 4,026,348 controls the rate of heat transfer by controlling the amount of condensate that flows back to the evaporator. However the introduction of an additional bulb to hold the condensate significantly increases the void volume, which in turn increases the activation energy of the heat pipe.

In U.S. Pat. No. 6,167,955 the flow of heat transfer fluid is regulated in response to changes detected by a sensor. In this patent the objective is achieved by disposing the valve between the first section and second section of the heat pipe. This valve regulates the flow of heat transfer fluid between the first section and the second section of the heat pipe in response to change detected by the heat pipe. In this case the construction of the valve is complex and expensive.

In U.S. Pat. No. 5,771,967 a means is provided whereby temperature is actively controlled to within a narrow range while heat transport varies over a wide range. In this patent a sliding wick has been used, the position of which is controlled by means of a temperature sensitive metal strip. Whenever a discontinuity occurs in wick, the heat pipe seizes to operate. This system has an additional component that makes the system complex in construction and operation. The limitation is that once it is set for a particular temperature range, this heat pipe would not operate over another temperature range.

In U.S. Pat. No. 4,974,667 heat is transferred intermittently by stopping the condensate from flowing back to the evaporator.

In U.S. Pat. No. 4,437,510 an unidirectional flow of heat is achieved using a check valve, which is operated by very low pressure that is placed in the vapour channel of heat pipe and allows the vapour to flow only in the forward direction from heat source to heat sink.

An ideal switchable heat pipe should be compact, simple to operate with minimum number of components, should have low thermal mass and internal voids. The prior art on switchable heat pipes listed above do not satisfy all these criteria and hence the long felt need to design heat pipes that would meet such requirements.

Heat driven sorption refrigeration cycles have existed in literature since 1909, and refrigerators are commercially available since 1920's. Environment friendly solid sorption systems with non-polluting refrigerants can efficiently use natural gas or solar energy as primary energy. Further this provides a system with no moving parts making it silent and maintenance free. Adsorption heating and cooling is therefore a good alternative to classical vapor compression systems. Adsorption cooling units are attractive as they can be operated at temperatures in which liquid absorption systems cannot work. The desirable features are high coefficient of performance (COP), high specific cooling power (SCP) and the thermodynamic efficiency, which is the ratio between the COP and the Carnot COP.

The thermodynamic efficiency of the adsorption heat pumps is much lower than that of the conventionally employed compression heat pumps. Adsorption heat pumps are generally suitable for waste heat and solar energy based operation.

U.S. Pat. No. 4,183,227 disclose an adsorption based heat pump providing semi-continuous or substantially continuous refrigeration and/or heating. The limitations of such systems are intermittency in supply of useful cooling or heating effects and varying heat delivery temperatures.

Continuous delivery of output with small temperature variation is achieved through ‘regenerative cycles’ in which at least two reactors operate out of phase with internal heat recovery. U.S. Pat. Nos. 5,347,815, 5,046,319 of Jones, and U.S. Pat. Nos. 4,694,659, 4,610,148 of Shelton disclose various ways of implementing separate heat transfer fluid loop passing through the bed for regeneration. Heat transfer fluid loop in the regenerative cycle helps increase COP. However, in such systems pumps are required to circulate the heat transfer fluids through the beds, valves and their control systems are needed to regulate and divert the flow in various loops. This results in operational complexity and increased capital cost due to requirements of pumps valves and their controls. Such systems are not suitable for very small capacities (e.g. 50 to 500 W).

U.S. Pat. No. 5,847,507 discloses an efficient adsorption based thermal compressor which used heat recycling. The system uses a thermal storage device for storing the heat released during adsorption which is used in next cycle during generation. Technology for heat transfer fluid loops is disclosed in U.S. Pat. No. 5,847,507. Its cost is high and requires thermal storage, pumps and associated controls. These systems are also not suitable for very small capacities (e.g. 50 to 500 W).

U.S. Pat. Nos. 4,765,395 and 5,079,928 disclose a scheme of cascading reactors, each using a solid adsorbent and refrigerant. Heat released during adsorption in one module is used for generation in the subsequent module. COP is increased by exchanging heat between the reactors. But, this arrangement is not appropriate for small refrigeration systems.

U.S. Pat. No. 5,477,705 discloses an adsorption system in which the reactor has separate compartments. It has means for circulation of heat transfer fluid through hot and cold reactors in such a fashion that a solid sorbent temperature front successively passes through the first compartment to the last and vice versa. This allows the efficient recycling of heat. However this requirement of several valves and controls complicates the system and increases the capital cost. Literature review by Wang and Dieng (“Literature review on solar adsorption technologies for ice-making and air-conditioning purposes and recent developments in solar technology”, Renewable & Sustainable Energy Reviews, Vol. 5, pp. 313-342, 2001) on solar adsorption systems indicates that to produce simple and cost effective devices more attention is needed to reduce the number of valves.

U.S. Pat. No. 4,594,856 describes a single stage pressure equalization technique, which increases the COP, but the complexity of the system makes this system inappropriate for small capacities.

Cycle time plays an important role in determining the compactness of the system. Cycle time can be decreased in adsorption refrigerators and heat pumps by improving heat and mass transfer rates. But, increasing heat transfer area to increase heat transfer rates leads to increase in thermal mass which increases thermal cycling losses and leads to reduction in COP.

Applicants recognized that the desirable features of the adsorption refrigeration system are:

a. improved COP

b. high specific cooling power leading to compact unit

c. regeneration without separate fluid loops

d. reduced cycle time

e. simple operational controls

f. flexibility of using waste heat

Applicants found the following problems with the conventional refrigeration systems.

The LD regeneration process/system ideally should exhibit the following attributes:

Energy efficient multi effect regenerator in which latent heat of vapour from the boiler is recycled

Elimination of carryover of LD in the process air as well as regeneration air, by elimination of spraying of LD

High area density for mass transfer equipment to make the system compact

Elimination of regeneration air blower

In the field of regeneration of LD, the challenges have been to make the process techno-economically viable by designing features to meet the needs of regeneration and achieve with significant reduction in the consumption of electrical power. It is desirable to increase the specific water removal rate from the LD. The specific water removal rate is the water removed from the LD in kg/kWh of heat input. It is desirable to increase this value in order to make the regeneration process efficient.

In the field of hybrid cooling systems the challenges have been to make them techno-economically viable by designing features to meet the needs of dehumidification, decrease in temperature, eliminating carryover of LD in to air streams and operate with significant reduction in electrical power consumption.

### SUMMARY OF THE INVENTION

The main object of the present invention is to provide a novel energy efficient multi-stage regeneration process, for regenerating liquid desiccant (LD), with application of rotating contacting disks to provide intimate contact between LD and vapour/gas to enhance the interfacial area between them for increased heat and/or mass transfer, without problems of carryover of liquid in to the vapour/gas stream or flooding having the provision to heat/cool the liquid based on the application. Further it is an object of the invention to explore applications in Hybrid Cooling Systems (HCS), in which air temperature and humidity are simultaneously controlled using a contacting device, which meets the needs of dehumidification, decrease in temperature and significant reduction in electrical power consumption with increase in cooling and/or dehumidification capacity for a given refrigeration compressor.

One of the objects of the invention is to regenerate the LD with higher specific water removal rates.

Another object of the invention is to develop HTR with no carryover of LD in to the steam, in which water rich LD boil to remove water in the form of steam, while performing the operation of regeneration of LD.

Another object of the invention is to develop HTR, which operates at atmospheric pressure.

Another object of the invention is to pass the partially regenerated LD from HTR to LTR for further regeneration or pass the partially regenerated LD from LTR to HTR for further regeneration or split the flow of LD into two streams and pass them to HTR and LTR

Another object of the invention is to provide intimate contact between LD and air to enhance the interfacial area between the vapour/gas stream and LD using large heat and mass transfer area, which ensures no carryover of LD in to the outdoor air stream, while, regenerating LD.

Another object of the present invention is to develop regenerator that has no limit on liquid throughput leading to high efficacy of the process (by reducing recirculation losses at lower liquid throughputs).

Another object of the invention is to provide a contacting device that operates with low power consumption.

Yet another object of the invention is to deliver the latent heat of the vapour generated in HTR to LD in LTR for regeneration.

Yet another object of the invention is to use alternate materials to reduce the weight and cost, while eliminating corrosion problems.

Yet another object of the invention is to develop a multi-stage regenerator comprising of Intermediate Temperature Regenerator/s (ITRs) to operate in conjunction with the HTR and LTR.

Another object of the invention is to provide a contacting device that incorporates surface density in the rage of 450 to 600 m²/m³, which is far superior to conventional polypropylene Rauschert Hiflow rings of size 2.54 cm having surface density of 210 m²/m³.

Yet another object of the invention is to provide a contacting device that does not have any carryover of liquid with the vapour/gas stream.

Yet another object of the invention is to provide a contacting device to operate with pressure drop across the contacting device as low as 5 Pa.

Another object of the present invention is to provide a contact device that has no limit on liquid throughput leading to high efficacy of the selective applications.

Another object of the invention is to provide a contacting device that operates with low power consumption.

Another object of the invention is to provide an easy to assemble contact device and yet providing sufficient rigidity to the contacting surface.

Yet another object of the invention is to provide a contacting device having the provision to heat/cool the liquid, vapour/gas, based on the application.

Another object of the invention is to provide design for HCS with significantly higher cooling capacity, than that of the VCRS using similar compressor.

Yet another object of the invention is to provide design for a HCS with significantly lower compressor displacement requirement as compared to that of a VCRS for a required cooling capacity

Yet another object of the invention is to develop an ICD a non-adiabatic or adiabatic absorber that ensures no carryover of LD to the indoor air stream, while performing operations of dehumidification and/or cooling of the indoor air stream.

Yet another object of the present invention is to develop an regenerator/outdoor contacting device (OCD), a non-adiabatic or an adiabatic regenerator, that ensures no carryover of LD in to the outdoor air stream, while, performing the operation of regeneration of LD.

Yet another object of the invention is to use alternate materials to reduce the weight and cost, while eliminating corrosion problems.

Yet another object of the invention is to use the liquid-liquid heat exchanger to increase the cooling capacity and COP of the HCS.

The main object of the invention is to provide system based on adsorption cycle having high coefficient of performance (COP), high specific cooling power (SCP) with easy operability and lower cycle times using novel adsorption modules which are easy to fabricate and overcome the problems of low thermal conductivity of adsorbents, without increasing the thermal mass of the system. It also relates to refrigeration cum heating system that can be heated by various heat sources like solar energy, direct fuel fired systems and waste heat fired systems using said adsorption module. Further, it relates to switchable heat pipes with a system to actuate or isolate hot end from the cold end to transfer heat intermittently as per the requirement.

One of the objects of the present invention is to provide design for adsorption modules that make it possible to develop compact adsorption systems by overcoming the problems of low thermal conductivity of adsorbents without increasing the thermal mass of the adsorption modules, thereby increasing heat transfer rates and reducing cycle time while maintaining high efficacy of the cycles and processes in which they are used.

The other object of the invention is to achieve the low thermal mass using a set of passages to and from the containment vessels thereafter termed “passages”.

It is another object of the invention to provide designs of “passages” that function as heat pipes that are in thermal contact with the wall of the containment vessels in diverse configurations.

It is yet another object of the invention to provide design of a system of “passages” preferably constructed of the high conductivity material.

It is yet another object of the invention to provide design of a system of “passages” that preferably enable the use of the containment vessel wall itself as the fin thereby eliminating the need for separate fins.

It is yet another object of the invention to provide design of a system of “passages” that preferably enable the use of the containment vessel wall and partitions as the fins thereby eliminating the need for separate fins.

Another object of the invention is to provide design of a system of “passages” with the option of increasing or decreasing number of the “passages” per containment vessel based on the desired cycle time.

Another object of the invention is to provide design of a system of “passages” in a manner to reduce the effective thermal mass at the same time achieving high COP and high SCP.

Another object of the invention is to provide design of a system of shared “passages” between multiple containment vessels in a manner to reduce the effective thermal mass at the same time achieving high COP and high SCP.

Yet another object of the invention is to provide design of a system of “passages” in a manner that is simple to fabricate, easy to operate and provide options for a wide range of application involving heat transfer.

Another object of the invention is to provide low cost and compact refrigeration cum heating system, based on adsorption refrigeration cycle that can be heated by various sources like solar energy, direct fuel firing and waste heat.

Another object of the invention is to provide a system comprising of a plurality of adsorption modules operating out of phase, to give continuous refrigeration and/or heating.

Yet another object of the invention is to increase the COP of the system without a separate loop circulating the heat transfer fluid.

Another object of the invention is to provide regeneration using multi stage pressure equalization process.

Yet another object of the invention is to reduce cycle time without affecting COP.

Yet another object of the invention is to reduce life cycle cost of the adsorption system.

Another object of the invention is to use waste heat as heat source

Yet another object of the invention is to provide a means for simple control of the system

Another aspect of this invention relates to switchable heat pipes using a system for actuating or isolating the evaporator or condenser capable of transferring heat intermittently when desired, based on parameters of the system for applications where a common evaporator is connected to multiple condensers and enabling operating selective set of condenser where plurality of evaporators are connected to a single condenser

Another object of the invention is to provide a method for isolation of heat pipes as per need and application in a system of multiple heat pipes in the case of adsorption refrigeration module, which is to be periodically heated and cooled. For example, in the case of a tailored switchable heat pipe as in this invention, during the adsorption phase when the module needs to be cooled, the cooling heat pipe with its evaporator integrated with the module would be operative, while the heating heat pipe whose evaporator is integrated with the module would be switched off.

Another object of the invention is to provide means for the isolation of heat pipes as per need and application in a system of multiple heat pipes in the case where, heat transfer rate is to be varied while exchanging heat between to fix temperature source and sink. Heat transfer rate can be varied, in such a situation, by varying the number of active heat pipes.

Another object of the invention is to provide a cost effective means of isolating heat pipes as per need and application in a system of multiple heat pipes in a system of multiple heat pipes in case of application where several heat pipes are to be switched on and off as per a desired sequence. It is also possible to pinch multiple squeezable tubes fixed on a large number of heat pipes using a single low cost drive mechanism.

Yet another object of the invention is to provide for a simple, easily implementable and maintainable means for the isolation of heat pipes as per the need and application.

Thus in accordance with the invention for example a single stage regeneration process comprises of:

LTR, which incorporates large surface density contacting device, having provision to heat the LD, with the hot fluid passing through passages, which are in thermal contact with a container such as a the containing the LTR

Optional arrangement such as a hood with chimney to aid the flow of ambient air through LTR to pickup the moisture from LD.

A device to rotate/oscillate the contacting disc assembly in the LTR

Further in accordance with the invention the single stage regeneration process may be extended to a two-stage regeneration process in a system comprising:

HTR, in which weak LD boils absorbing heat from an external source, having insulation on exposed surface to avoid heat loss from LD to surroundings

LTR, incorporating large surface density contacting device, having provision to heat the LD, with vapour generated in HTR condensing in passages which are in thermal contact with a container such as a trough containing the LTR

Optional arrangement such as a hood with chimney to aid the flow of ambient air through LTR to pickup the moisture from LD.

A device to rotate/oscillate the contacting discs assembly in the LTR

Optional heat exchanger used to recycle heat to enhance the energy efficiency of the process

Liquid desiccant pump

Further in accordance with the invention the two-stage regeneration process may be extended to a multi-stage regeneration process in a system comprising:

HTR operating at highest pressure in the system boiling the weak LD absorbing heat from an external source, having insulation on exposed surface to avoid heat loss from LD to surroundings and giving off vapour to next, relatively low temperature ITR, in which the latent heat of vapour generated in HTR is used to boil the LD.

ITR operating at a particular pressure heated using the vapour generated in the ITR/HTR operating at next higher-pressure level wherein the vapour generated in the ITR is passed on to the next ITR/LTR operating at next lower pressure level.

A LTR, operating at atmospheric pressure, incorporating large surface density contacting device, having provision to heat the LD, with vapour generated in immediate higher temperature HTR/ITR condensing in the passages, in thermal contact with a container such as a the containing the LTR

Optional arrangement such as a hood with chimney to aid the flow of ambient air through LTR to pickup the moisture from LD.

A device to rotate/oscillate the contacting discs assembly in the LTR

Optional heat exchangers HTRHE, ITRHE and LTRHE used to recycle heat to enhance the energy efficiency of the process

Pressure reducing devices such as throttle valve

Liquid desiccant pump(s)

The number of stages in regeneration process may be increased by appropriately adding ITRs, liquid-liquid heat exchangers and pressure reducing devices between HTR and LTR.

The contacting device providing intimate contact between fluids to enhance the interfacial area between them comprises of:

assembly of contacting discs

shaft for mounting the contacting discs for increased heat and/or mass transfer

device for rotating/oscillating the contacting discs assembly

trough to hold fluids in which the disc assembly is partially or fully submerged

passages in thermal contact with a trough

optional device to induce vapour/gas flow

optional enclosure with arrangement to guide the flow of vapour/gas

The Hybrid Cooling System (HCS) in accordance with the invention comprises:

An absorber/Indoor Contacting Device (ICD), for dehumidifying air by bringing it in contact with the LD while being cooled by evaporating refrigerant in the integrated evaporator

A regenerator/Out Door Contacting Device (OCD) for regenerating LD by bringing it in contact with air, while LD being heated by condensing refrigerant in the integrated condenser

A refrigerant compressor, to compress the refrigerant vapour coming from absorber/ICD after absorbing heat from LD and send the high pressure refrigerant vapour to regenerator/OCD for delivering heat to the LD

A throttling device, for throttling liquid refrigerant moving from regenerator/OCD to absorber/ICD

Optional liquid-liquid heat exchanger to recycle heat from the hot regenerated strong LD flowing from the regenerator/OCD into the weak LD pumped out of the absorber/ICD

Two optional LD pumps to pump the LD, one from the absorber/ICD to regenerator/OCD and the other from the regenerator/OCD to absorber/ICD

Optional refrigerant liquid to vapour heat exchanger to sub cool the liquid refrigerant coming out of the condenser using the cooling effect of refrigerant vapour coming out of the evaporator

Optional Spiral Contacting Device (SCD) incorporated by the absorber/ICD and regenerator/OCD

Optional external refrigerant evaporator/LD cooler instead of integrated evaporator with absorber/I CD

Optional external refrigerant condenser/LD heater instead of integrated condenser with regenerator/OCD

Optional device to circulate the indoor air through the absorber/ICD and outdoor air through regenerator/OCD

Optional duct mounting of absorber/ICD and regenerator/OCD

### DETAILED DESCRIPTION OF THE INVENTION

Other features and advantages of this invention will become apparent in the following detailed description of the preferred embodiments of this invention with reference to the accompanying drawings, in which:

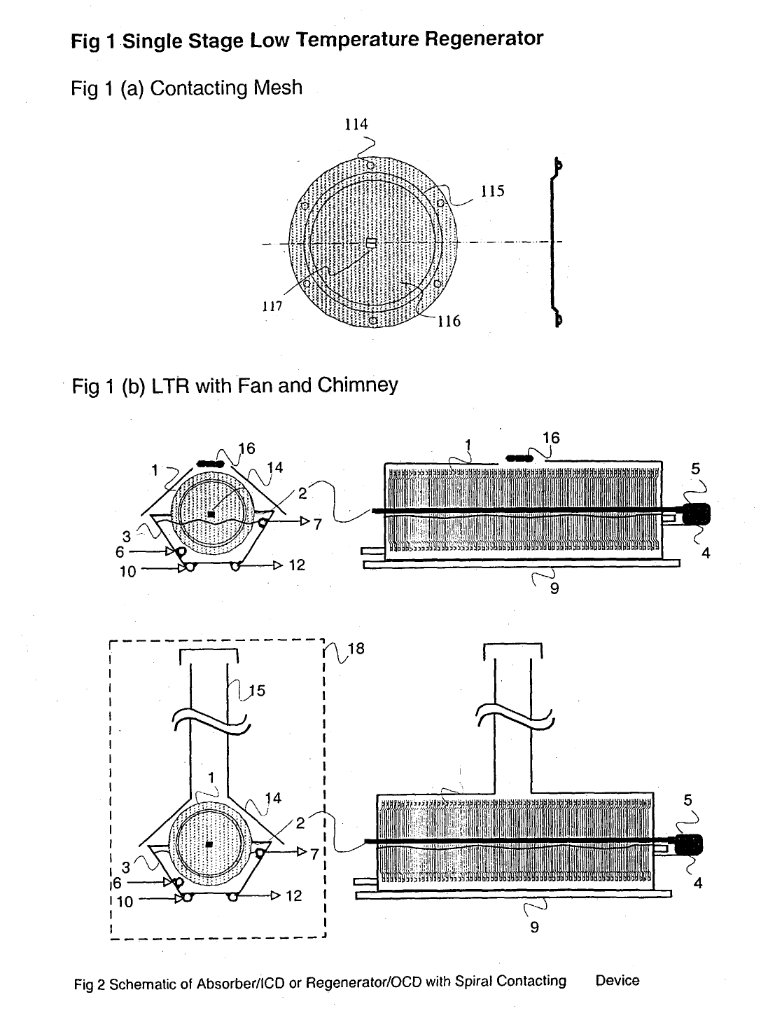

FIG. 1a is a contacting mesh

FIG. 1b a single stage low temperature regenerator with fan and chimney

FIG. 2 is a schematic of absorber/ICD or regenerator/OCD with spiral contacting device (SCD)

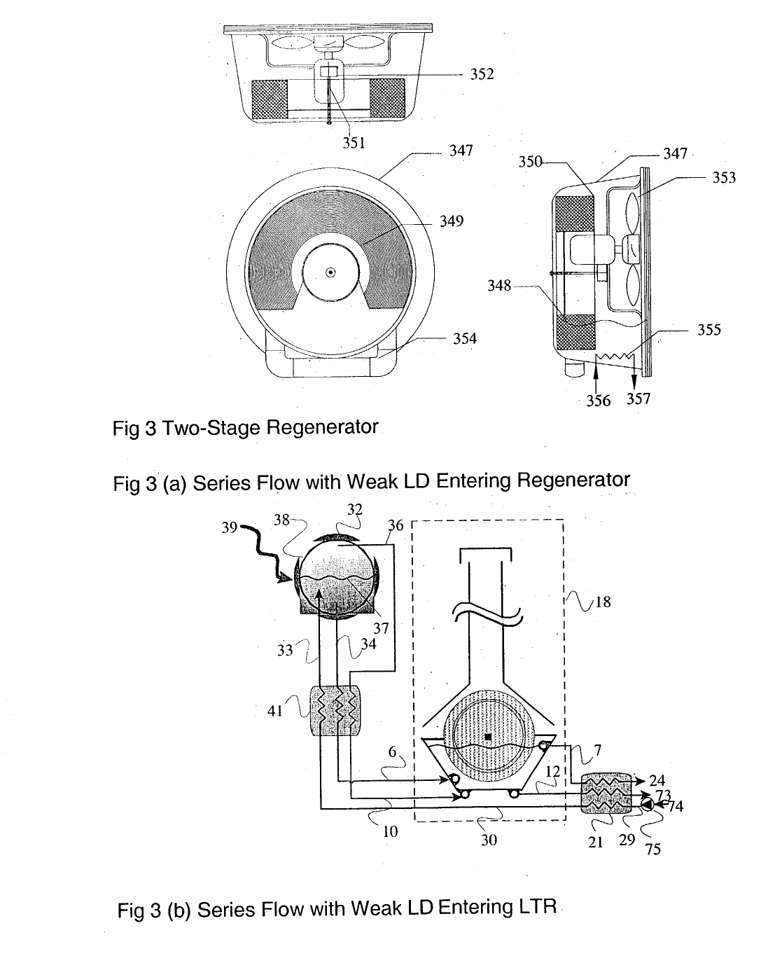

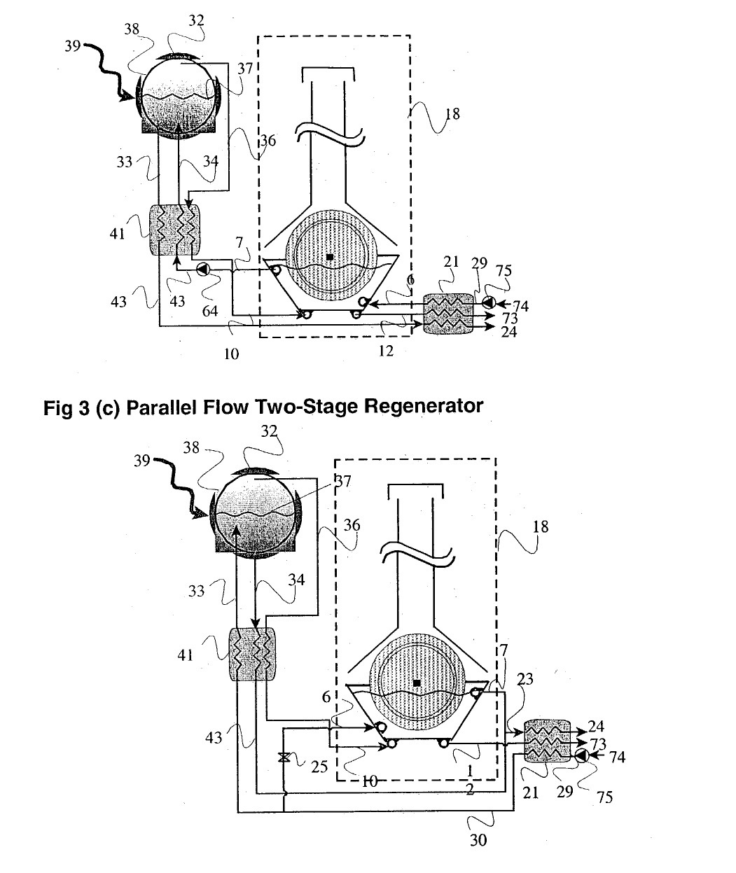

FIG. 3a is a a series flow two-stage regenerator with weak LD entering HTR

FIG. 3b is a series flow two-stage regenerator with weak LD entering LTR

FIG. 3c is a parallel flow two-stage regenerator

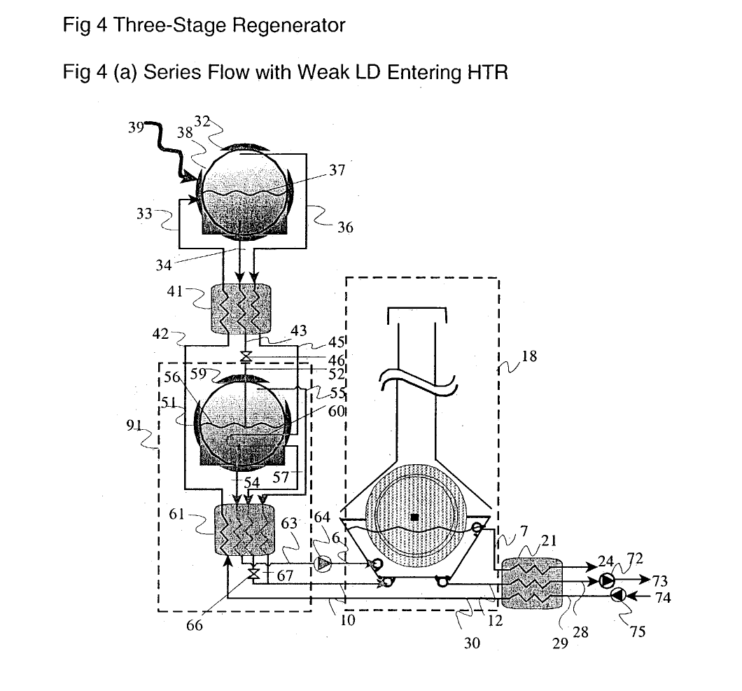

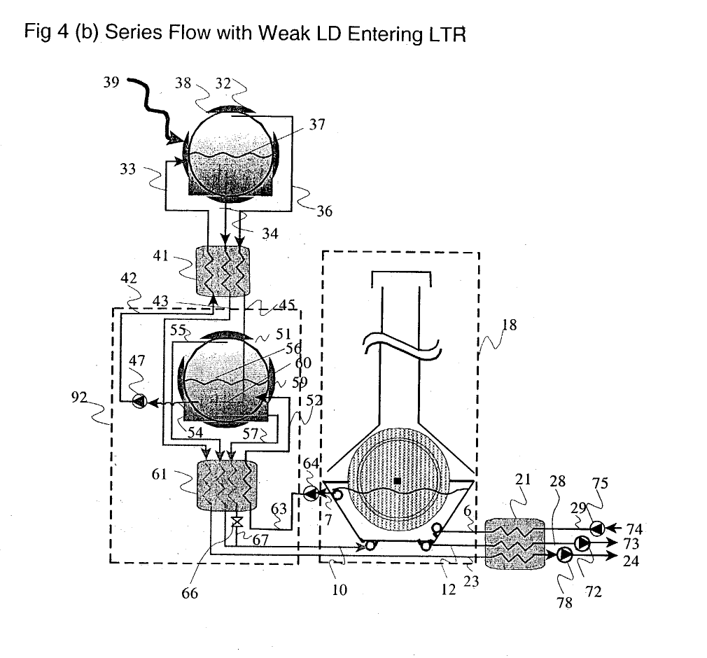

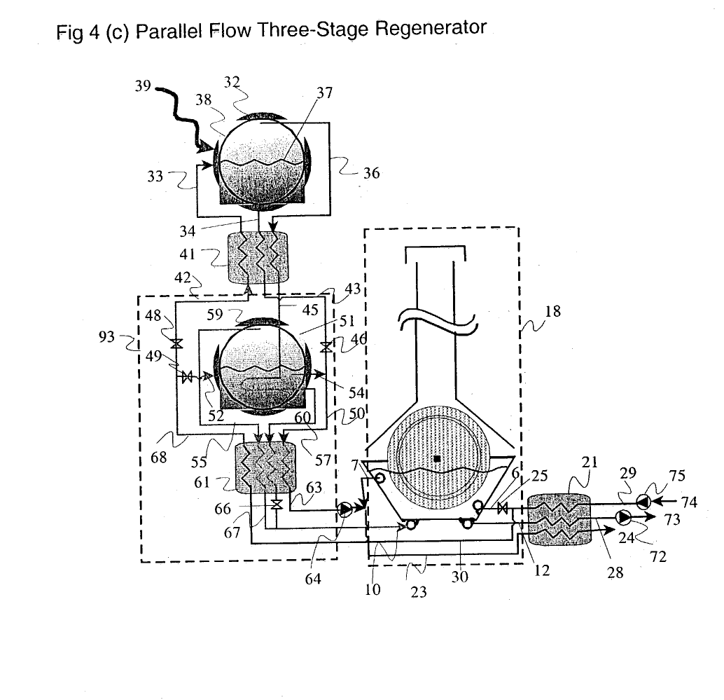

FIG. 4a is a series flow three-stage regenerator with weak LD entering HTR

FIG. 4b is a series flow three-stage regenerator with weak LD entering LTR

FIG. 4c is a parallel flow three-stage regenerator

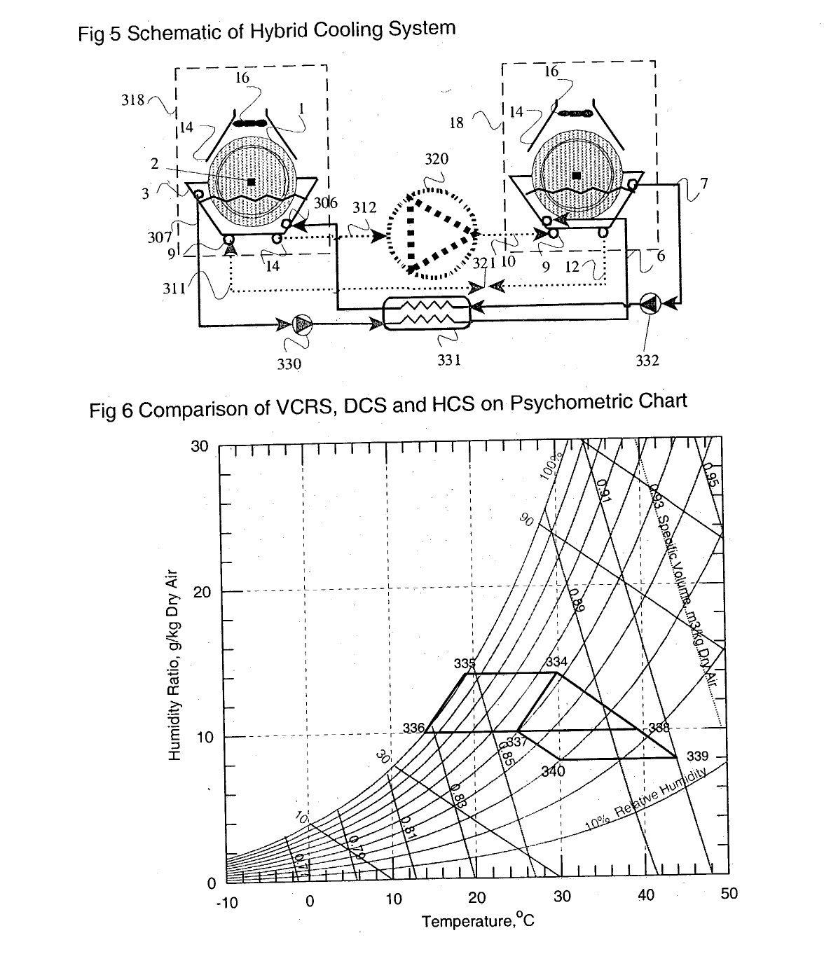

FIG. 5 is a schematic of the hybrid cooling system

FIG. 6 shows a comparison of VCRS, DCS and HCS on psychrometric chart

FIG. 1a shows the contacting mesh for the mass transfer. Dimples, 114 are provided to give the required gap between the discs, when they are assembled on the shaft. Dimples on the mesh are providing the self-spacing between the discs. This leads to reduction in time required to assemble the discs on the shaft. The depth and diameter of the dimple can be varied. The spacers of required thickness on the shaft can provide spacing between the discs. This eliminates the dimples on the circumference of the disc A lip, 115 on the circumference of the contacting disc provides enough rigidity to the contacting surface. Inner surface of the disc is 116. A square hole at the centre is 117. The discs can be thermally bonded with the shaft. Thermally bonded discs can be acting as fins and help in heat transfer between fluid in the trough and fluid flowing through the shaft.

FIG. 1b shows a single stage Low Temperature Regenerator. The disc, 1 provides the contacting surface between the LD and air. The contacting surface is the mesh, or roughened surface, which holds the liquid on the surface for mass transfer. The disc, in plurality are mounted on a square hallow or solid shaft 2. A trough, 3 contains the LD. Material of construction of the trough can be a metallic, non-metallic or any other suitable, which is compatible with the LD and vapour/gas. The LD to be regenerated flows in to the trough 3 through inlet conduit 6. The regenerated LD flows out from the trough 3 through outlet conduit 7. Passages, 9 in plurality are in thermal contact with the trough. They can be inside/outside or integrated with the wall of the trough and be used for heat transfer to the LD in the trough. The passages can be metallic or non metallic or any other suitable material, which is compatible with fluid flowing through it. A hood, 14 is provided to ensure to vapour/gas passes in closed contact with contacting discs 1. Optionally a chimney 15 or a fan 16 is provided to circulate the air/gas through the contacting device. The heat transfer fluid is supplied through conduit 10 to the passages 9 wherein it exchanges heat with the LD in the trough and leaves through conduit 12. A device 5 is provided to rotate the contacting disc assembly and is supported on support 4.

The surface of the contacting disc can hold large quantity of the liquid. Rotating contacting surface partially dipped in a liquid eliminates the need for a pump to irrigate the contacting device. Thereby making the irrigation mechanism simpler. Carryover is eliminated if low vapour/gas velocities are maintained.

Fluid flowing through the passages, which are in thermal contact with the trough, can be a hot or cold fluid. The hot fluid can be steam, compressed air, exhaust gases from the engine or any hot fluids from suitable hot source. The cold fluid can be a cold refrigerant from heat pump, water from the cooling tower.

There are several variants of the contacting that may be designed as per the application.

In one of the embodiments the contacting disc may be a mesh, plain, roughened surface, and porous material.

Another embodiments the contacting device is preferably circular.

In other embodiments the contacting disc may be octagonal, hexagonal or any other shape based on the application.

In a specific embodiment the contacting device is of metal.

In other embodiments, the contacting may non-metallic or of any suitable material that is compatible with the fluids.

In one embodiment, the central hole in the contacting device preferably a non-circular cross section to ensure that the discs move along with the shaft. In yet another embodiment the hole in the contacting can be circular.

In one of the embodiments, the contacting disc may optionally have dimples/projectio'ns on the circumference to provide self-spacing when the discs are assembled on a shaft.

In other embodiments, the contacting discs do not have dimples, but spacing between the discs is provided with spacers.

In the other embodiments the spacers may be metallic or non metallic or any other suitable, which is compatible with liquid and vapour/gas.

One of the preferred embodiments is a square shaft that could be passed through the square hole in the contacting disc.

In an embodiment of the contacting disc assembly the shaft may be a hollow or solid as per the application.

In an embodiment of the contacting disc assembly the shaft is metallic.

In other embodiments, the shaft may be non-metallic or any other suitable material, which is compatible with the fluids.

In one of the embodiments, the trough holding the liquid may have the discs that are partially submerged.

In the other embodiments, material of construction of the trough may be a metallic, non-metallic or of any suitable material, which is compatible with the fluids.

In one of the embodiments, the heat exchanging passages on the trough is a coil, or multiplicity of tubes of any material in thermal contact with the inner or outer surface of the trough or integrated into the trough.

In other embodiments, the material of the passages may be metallic, non-metallic, or any other suitable material, which is compatible with the fluid flowing through it.

In one of the embodiments, a cover with chimney is provided to circulate the vapour/gas through the device.

In the other embodiments, the material of construction of enclosure to guide the flow of vapour/gas may be metallic or non metallic which is compatible with the fluids. In one of the embodiments, a low speed drive may be used to rotate the contacting disc assembly.

FIG. 2 shows one of the preferred embodiments of the absorber/ICD or regenerator/OCD with spiral contacting device (SCD). A trough 347, is the housing to contain the LD 348. The contacting spiral mesh is wound on a housing 350. The spiral-contacting device is 349. A shaft 351 at the centre of the SCD is connected to an electric motor 352. The SCD is rotated by a motor at low rpm in the LD, preferably at around 3 to 5 rpm or oscillated to angle greater than 30° in either direction. A fan 353 is provided to circulate indoor air in case of absorber/ICD and outdoor air in case of regenerator/OCD. In an embodiment the fan may be a forced/induced draft fan. A support 354 is provided to the trough. The heat exchanger in the trough of absorber/ICD or regenerator/OCD is 355. Refrigerant passes to the heat exchanger through the conduit 356 to cool the LD in case of absorber/ICD and to heat the LD in case of regenerator/OCD. The outlet of refrigerant from the absorber/ICD or regenerator/OCD is 357.

FIG. 3a shows a series flow two-stage regenerator with weak LD entering HTR. The weak LD from the source passes to the pump 75 through inlet conduit 74 and is pumped to LTRHE 21, through conduit 29 and where it is heated, further it passes through conduit 30 and gets heated in High Temperature Regenerator Heat exchanger (HTRHE) 41 further and then through conduit 33 it is introduced in to HTR 32. Vapour is generated from the LD at high temperature and pressure due to the addition of heat 39. This vapour passes through conduit 36 and gets sensibly cooled in HTRHE 41, further it passes through conduit 10 and flows through the passages of LTR 18 and gets condensed completely in passages of LTR. This condensate then passes through conduit 12 and further passes through Low Temperature Regenerator Heat Exchanger (LTRHE) 21 where it gets sub cooled further. This condensate is collected from the outlet conduit 73.

Partially regenerated LD from HTR 32 exits through conduit 34 and then passes through HTRHE 41 where it gets sub cooled and passes to LTR 18 through conduit 6. After complete regeneration of LD in LTR it exits through conduit 7 and then passes through LTRHE 21 where it gets sub-cooled and the regenerated LD leaves through conduit 24.

The vapour generated in HTR flows to HTRHE, 41 through conduit 36 and gets desuperheated and the desuper heated vapour flows to the LTR 18 through conduit 10 and is condensed in passages thermally in contact with LTR 18 and the condensate from LTR flows to LTRHE 21 through conduit 12 and then subcooled in LTRHE and comes out through conduit 73.

FIG. 3b shows a series flow two-stage regenerator with weak LD entering LTR. The weak LD from the source passes to the pump 75 through inlet conduit 74 and is pumped to LTRHE 21, through conduit 29 and where it is heated, further it passes to LTR through conduit 6 then it is partially regenerated in LTR. Partially regenerated LD from LTR flows through the conduit 7 to the suction of the pump 64 and pumped through HTRHE 41 where it is preheated and then flows to HTR 32 through conduit 34. The LD level in the HTR is 37 and the insulation to HTR is 38. In the HTR the LD is-fully regenerated by absorbing heat from the heat source 39. The fully regenerated LD from HTR flows to HTRHE 41 through conduit 33 and then subcooled in HTRHE and flows to LTRHE 21 through conduit 43, where it is subcooled further before being returned to the source through conduit 24.

The vapour generated in HTR flows to HTRHE, 41 through conduit 36 and gets desuperheated and the desuper heated vapour flows to the LTR 18 through conduit 10 and is condensed in passages thermally in contact with LTR 18 and the condensate from LTR flows to LTRHE 21 through conduit 12 and then subcooled in LTRHE and comes out through conduit 73.

FIG. 3c shows a parallel flow two-stage regenerator. The weak LD from the source passes to the pump 75 through inlet conduit 74 and is pumped to LTRHE 21, through conduit 29 and where it is heated and passes through conduit 30, and part of the LD flow is throttled into the LTR in throttling device 25 and fully regenerated and the other part of the LD flow is preheated through HTRHE, 41 on its way to HTR. The LD level in the HTR is 37 and the insulation to HTR is 38. In the HTR the LD is fully regenerated by absorbing heat from the heat source 39. After regeneration the LD flows to the HTRHE, 41 through conduit 34 where it is subcoled and then further it passes through conduit 43 before being combined with the fully regenerated LD stream from LTR 18 and then flows through conduit 23 and further passes through LTRHE 21 where it is subcooled before being returned to the source through condut 24.

The vapour generated in HTR flows to HTRHE 41 through conduit 36 and gets desuperheated and the desuperheated vapour flows to the LTR 18 through conduit 10 and is condensed in passages thermally in contact with LTR 18 and the condensate from LTR flows to LTRHE 21 through conduit 12 and then subcooled in LTRHE and comes out through conduit 73.

FIG. 4a shows a series flow three-stage regenerator with three pumps and two throttle valves. The weak LD from the source passes to the pump 75 through inlet conduit 74 and is pumped to LTRHE 21, through conduit 29 and then is heated, further it passes through conduit 30 and gets heated in Intermediate Temperature Regenerator Heat exchanger (ITRHE) 61, further it passes through conduit 42 which leads it High Temperature Regenerator Heat exchanger (HTRHE) 41 where it gets heated further and then through conduit 33 it is introduced into HTR 32. Vapour is generated from the solution at high temperature and pressure due to the addition of heat 39. This vapour passes through conduit 36 and gets sensibly cooled in HTRHE 41, further it passes through conduit 45 and condenses in heat exchanger 60 and further condensate passes through ITRHE 61 where it gets subcooled and it passes through throttle valve 66 and is led through conduit 10 after mixing with vapour coming from ITR 51 through conduit 67. This condensate vapour mixture condenses completely in passages of LTR 18 and then passes through conduit 12 and further passes through Low Temperature Regenerator Heat Exchanger (LTRHE) 21 where it gets sub cooled further. This low-pressure condensate stream is then pumped using pump 72 to atmospheric pressure. The condensate is collected from the outlet conduit 73.

Partially regenerated LD from HTR 32 is led through conduit 34 into HTRHE 41 where it gets sub cooled before it is throttled in throttling device 46 and led through conduit 52 into ITR 51. Vapour is generated in ITR 51 at intermediate temperature and pressure due to heat delivered through heat exchanger 60. This vapour passes through conduit 55 which is desuperheated in ITRHE 61 and further it passes through conduit 67 leading to conduit 10. Partially regenerated LD from ITR 51 which operates under vacuum passes through conduit 54 which leads into LD pump 64 which increases the pressure of the LD from ITR to atmospheric pressure which is then led in to trough of LTR 18.

After complete regeneration of LD in LTR it is led through conduit 7 to LTRHE 21 where it gets sub-cooled further. The regenerated LD flows out through outlet conduit 24.

FIG. 4b shows a series flow three-stage regenerator with weak LD entering LTR. The weak LD from the source passes to the pump 75 through inlet conduit 74 and is pumped to LTRHE 21, through conduit 29 and then is heated and further passes to LTR 18 through conduit 6 and partially regenerated in the LTR then pumped to ITRHE 61 with pump 64, through conduit 7, where it is preheated before it is regenerated further in ITR 51. The partially regenerated LD is pumped to HTR 32 with pump 64 through the HTRHE 41 where it is preheated through HTRHE and passes to HTR through conduit 33 and regenerated further in HTR thereafter the fully regenerated LD flows to HTRHE wherein it is subcooled, and passes to ITRHE through conduit 43 and further flows to LTRHE 21 through conduit 23 and then pumped back to the source through conduit 24

The vapour generated in HTR flows to HTRHE 41 through conduit 36 and gets desuperheated and the desuperheated vapour flows to the ITR 51 and gets condensed and further subcooled in ITRHE 61 and throttled in throttling device 66 and mix with the vapour generated in ITR. This liquid vapour stream is then condensed in “passages” thermally in contact with LTR, 18 and the condensate from LTR passes to LTRHE 21 through conduit 12 and subcooled in LTRHE before being pumped out through conduit 73.

FIG. 4c shows the parallel flow three stage regenerator. The weak LD from the source passes to the pump 75 through inlet conduit 74 and is pumped to LTRHE 21 through conduit 29 and then it is heated and a portion of the LD further passes to LTR 18 through conduit 6 through throttling device 25 and conduit 6. Another portion of weak LD passes through conduit 30 to ITRHE 61. This stream of LD passes from ITRHE 61 to ITR 51 through conduit 68 and portion of this stream is taken into ITR 51 through throttling device 49 and conduit 52. The remaining portion of this stream flows through throttle valve 48 and conduit 42 to HTRHE 41 and flows through conduit 33 to HTR. The partially regenerated LD from LTR 18 passes through pump 64 through conduit 63 to ITRHE 61 and flows to HTR 32 through HTRHE.

The vapour generated in HTR flows to HTRHE 41 through conduit 36 and gets desuperheated and the desuperheated vapour flows to the ITR 51 through conduit 45 and gets condensed in the heat exchanger 60 in ITR and flows to the ITRHE through conduit 57 and further subcooled in ITRHE 61 and throttled in throttling device 66 and mix with the vapour generated in ITR. This liquid vapour stream is then condensed in “passages” thermally in contact with LTR, 18 and the condensate from LTR passes to LTRHE 21 through conduit 12 and subcooled in LTRHE before being pumped out through conduit 73.

The number of stages in regeneration process may be increased by adding ITRs, liquid-liquid heat exchangers and pressure reducing devices between HTR and LTR.

In one of the embodiments, the heat source to the HTR is electric heater, solar collector, burning of biomass or biogas.

In the other embodiment, the heat source to the HTR may be waste heat source from the engine exhaust or any other waste heat source.

In one of the embodiments, the HTR may be a metallic or non-metallic, which is compatible with LD.

In the other embodiment, the shape of the HTR may be a cylindrical, rectangular, square or any other suitable shape for integration with the heat source.

In the other embodiment the HTR may be placed horizontally, vertically or any position suitable for integration with the heat source.

In one of the embodiments the HTR is covered with insulating material to avoid heat transfer between LD and ambient.

In one of the embodiments, a solution heat exchanger is incorporated to preheat the weak LD flowing to HTR, using heat from high temperature LD flowing from HTR.

In one of the embodiment, additional solution heat exchangers may be incorporated to internally recycle heat from hot to cold LD.

In the other embodiment, the material of construction of heat exchanger may be a plastic or any other suitable material compatible with LD.

In one of the embodiments entire flow of the LD, after regeneration in HTR is flowing through LTR. In this case, HTR and LTR are operating in series.

In the other embodiment certain flow of LD after regeneration in HTR may be bypassed. In this case HTR and LTR are operating in parallel.

In another embodiment partially regenerated LD passes from the HTR to LTR for further regeneration or the partially regenerated LD may pass from LTR to HTR for further regeneration or the flow of LD is split into two streams and then passed to HTR and LTR

In another embodiment, the LTR incorporates rotating disks as the contacting media between LD and vapour/gas.

In one of the embodiments, the condensation of vapour takes place in the passages, which are in thermal contact with the LTR.

In a specific embodiment the passages, through which vapour condenses may be in thermal contact while being inside or outside or integrated with LTR.

In one of the embodiments an arrangement such as a hood with chimney is provided to aid the ambient air through the LTR over the contacting media, which is wet with LD.

In one of the embodiments, the HTR is at a higher elevation than the LTR, and one LD pump is used to pump the weak LD to HTR.

In another embodiment, two pumps are used, one pump to LTR and the other to HTR.

In the other embodiment, one pump to pump LD to LTR and LD from LTR flows due to gravity.

In another embodiment, the heat source to the ITR may be the vapour generated in HTR.

In other embodiments, the ITR may be a metallic or non-metallic, which is compatible with LD.

In the other embodiment the shape of the ITR may be a cylindrical, rectangular, square or any other suitable shape for integration with the heat source from ITR/HTR operating at next higher pressure level.

Yet other variants of this invention with more than two-stages of regeneration, which incorporates additional components such as, ITRs, liquid-liquid heat exchangers and pressure reducing devices.

FIG. 5 shows a schematic diagram of the novel HCS. The system comprises of an absorber/ICD 318, which incorporates large surface density contacting discs 1, in plurality mounted on a shaft 2. The disc-assembly placed in a trough 3, containing the LD. The trough is made of any material that is compatible with the LD and air. A fan, 16 circulates the indoor air through the absorber/ICD, which gets dehumidified and cooled as it passes through the absorber. In an embodiment the fan may be a forced/induced draft fan. A hood, 14 guides the indoor air over the contacting disc assembly. Concentrated LD enters the absorber/ICD through conduit 306. Weak LD leaves the absorber/ICD through conduit 307. The contacting discs are partially submerged in the LD, in the absorber/ICD. The disc assembly is rotated by a drive at low rpm in the LD, preferably at around 3 to 5 rpm or oscillated to an angle greater than 30° in either direction. The refrigerant of VCRS is expanded in the throttle valve, 321 and the low temperature refrigerant flows in through conduit 311 to the passages 9, that are in thermal contact with the outer lower surface or inner surface or integrated with the trough wall of the absorber/ICD. The LD in the absorber/ICD is cooled as the refrigerant evaporates in the passages 9. The cooled desiccant in the absorber has high affinity to absorb the moisture from the indoor air. After absorbing the moisture from the indoor air, weak LD flows through conduit 307 and led to the pump 330, to the regenerator/OCD, 18 through a liquid-liquid heat exchanger 331. This heat exchanger is provided to heat the LD from the absorber/ICD and cool the desiccant stream as it flows from regenerator/OCD 18, which flows in to the absorber/ICD.

Refrigerant exits from the absorber/ICD through conduit 312 and moves to the compressor 320. Refrigerant after compression passes through conduit 10 to the passages 9 of regenerator/OCD, 18 which are in thermal contact with the outer lower surface or inner surface or integrated with the trough wall of the regenerator/OCD. The weak LD from absorber/ICD after liquid-liquid heat exchanger flows to the regenerator/OCD. The weak LD enters the regenerator/OCD through conduit 6. The heat required for the regeneration is supplied by the refrigerant condensing in the passages 9. After condensation of the refrigerant in regenerator/OCD, it moves through conduit 12 which led to throttling device 321.

The regenerated, strong LD flows out from the regenerator/OCD through conduit 7 and pumped with LD pump 332 to the absorber/ICD through the liquid-liquid heat exchanger, 331. A hood 14 is provided to guide the outdoor air through the regenerator/OCD. A fan 16 is provided to circulate the outdoor air through the regenerator/OCD. The contacting disc assembly is partially submerged in the LD in the regenerator/OCD. The ambient air pickups the moisture from the hot desiccant, in the trough of regenerator/OCD. The disc assembly is rotated by a motor at low rpm in the LD, preferably at around 3 to 5 rpm or oscillated to an angle greater than 30° in either direction.

FIG. 6 shows the ideal state points on psychrometric chart that the conditioned air experiences in VCRS, DCS and HCS. For VCRS, the air-conditioning process is represented by locus of 334-335-336-337, on psychrometric chart. For DCS, the process is represented by locus 334-338-339-340-337. For HCS, the process is represented by locus 334-338-337 and 334-337. Compared with the DCS and VCRS, HCS eliminates the process of cooling the air below its dew point temperature and reheating as in VCRS. HCS also eliminate the processes of deep dehumidification and re-humidification, which occurs in the DCS.

In one of the embodiments, an absorber/ICD is coupled with an evaporator of conventional VCRS.

In another embodiment, the absorber/ICD is an adiabatic contacting device with a separate heat exchanger to cool the LD.

In one of the embodiments, the evaporation of the refrigerant takes place in the passages, which are in thermal contact with the trough containing the LD.

In a specific embodiment, the passages may be in thermal contact by being placed inside or outside the trough or integral with trough.

In one of the embodiments an absorber/ICD and/or regenerator/OCD incorporates large surface density rotating contacting disc assembly as the contacting media between air and LD.

In another embodiment, the rotating contact disc assembly in the absorber/ICD and/or regenerator/OCD is a mesh, plain/roughened surface or porous material and their like constructed of materials such as a plastic or any other suitable material, which is compatible with LD and air.

In one of the embodiments the contacting disc assembly absorber/ICD and regenerator/OCD is rotated at low rpm in the LD, preferably at around 3 to 5 rpm or oscillated to an angle greater than 30° in either direction.

In another embodiment the contacting disc assembly in the absorber/ICD and/or regenerator/OCD is mounted in a trough or any suitable container constructed of non conducting material with wall thickness of <0.2 mm and to withstand the pressure of the heat transfer fluid.

In one of the embodiments the absorber/ICD and/or regenerator/OCD, optionally incorporates Spiral Contacting Device (SCD) as the contacting media between the LD and air.

In another embodiment SCD in the absorber/ICD and/or regenerator/OCD is rotated at low rpm in the LD, preferably at around 3 to 5 rpm or oscillated to an angle greater than 30° in either direction.

In one of the embodiments, SCD in the absorber/ICD and/or regenerator/OCD is mounted in a trough or any suitable container without passages.

In the other embodiment the trough to mount the SCD is constructed of conducting/non conducting material without limitation of wall thickness

In one of the embodiments, a liquid-liquid heat exchanger selected from any suitable material compatible with the LD may be incorporated in the system to recycle heat from the hot regenerated strong LD coming from the regenerator/OCD into the weak LD coming out of the absorber/ICD.

In one of the embodiments, a regenerator/OCD is coupled with a condenser of conventional VCRS.

In another embodiment, the regenerator/OCD is an adiabatic contacting device with a separate heat exchanger to heat the LD.

In one of the embodiments the condensation of the refrigerant takes place in the passages, which are in thermal contact with the inner or outer or integrated into the trough of regenerator/OCD.

In one of the embodiments the evaporation of the refrigerant takes place in the passages, which are in thermal contact with the inner or outer or integrated into the trough of absorber/I CD.

In the specific embodiment, where the elevation difference between the regenerator/OCD and the absorber/ICD is not sufficient, two LD pumps are used to pump the LD, one from the absorber/ICD to regenerator/OCD and the other from the absorber/ICD to regenerator/OCD.

In an embodiment the regenerator/OCD may be placed at higher elevation than the absorber/ICD in which case the LD flows by gravity from the regenerator/OCD to absorber/ICD In the specific embodiment, where the regenerator/OCD is at a higher elevation than the absorber/ICD, one LD pump is used to pump the LD from the absorber/ICD to regenerator/OCD.

In one of the embodiments, absorber/ICD may be placed at higher elevation than the regenerator/OCD in which case the LD flows by gravity from the absorber/ICD to regenerator/OCD.

In the specific embodiment, where the absorber/ICD is at a higher elevation than the regenerator/OCD, one LD pump is used to pump the LD from the regenerator/OCD to absorber/ICD

In another set of embodiments the said VCRS is replaced by Vapour Absorption/Adsorption System.

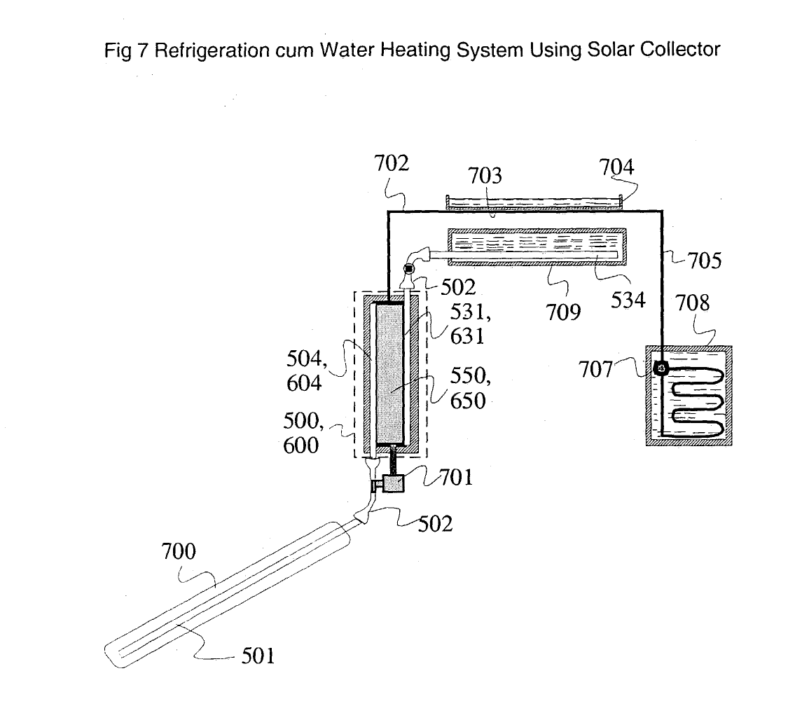

This invention provides a compact refrigeration cum heating system as described in FIG. 7 comprising a judicious combination of

a heat source

set of adsorption modules that operate out of phase, to give continuous refrigeration and/or heating,

switchable heat pipes in thermal contact with the wall and/or partition of the adsorption modules,

condenser,

evaporator,

heat pipes and

heat recovery unit

functioning to provide regeneration resulting in high COP, reduced cycle time, high specific cooling power and thermodynamic efficiency.

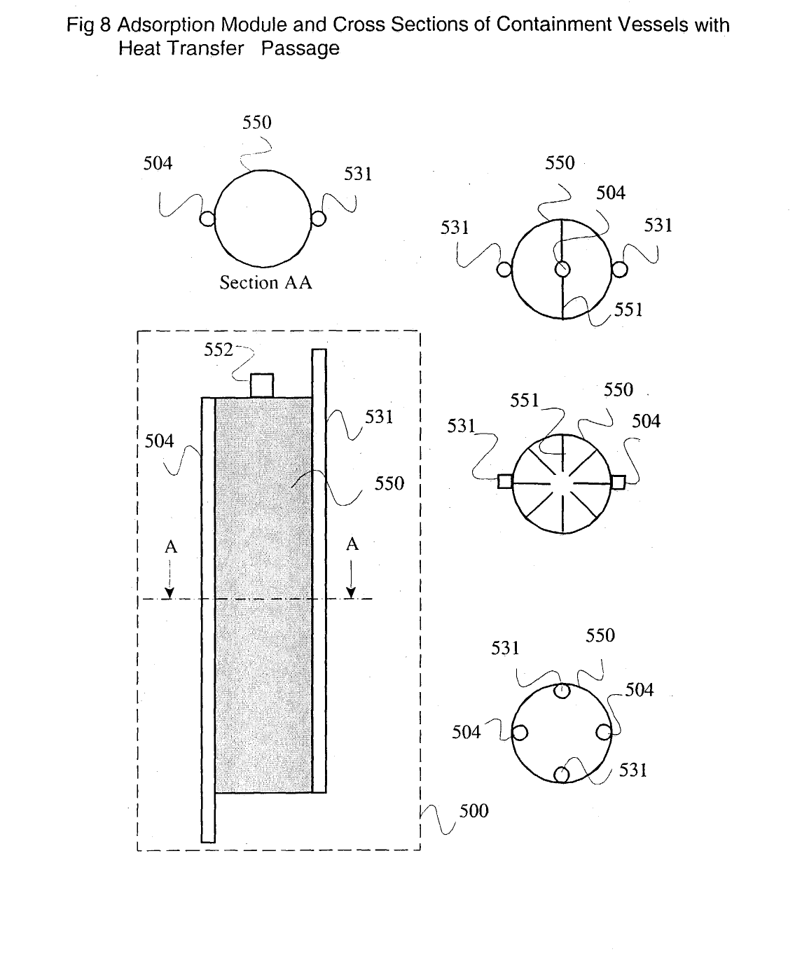

The adsorption module comprises (FIG. 8)

a. A main containment vessel in which adsorbent is filled

b. Two or more “passages”, in thermal contact with the containment vessel for heat transfer

c. The containment vessel and the “passages” preferably constructed of high conductivity material such as Aluminum

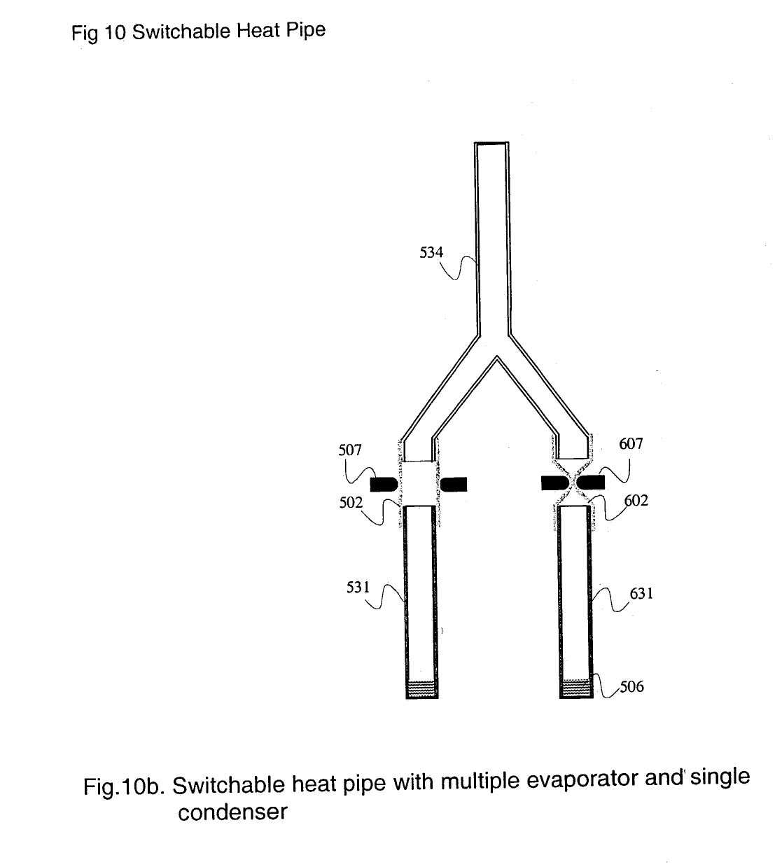

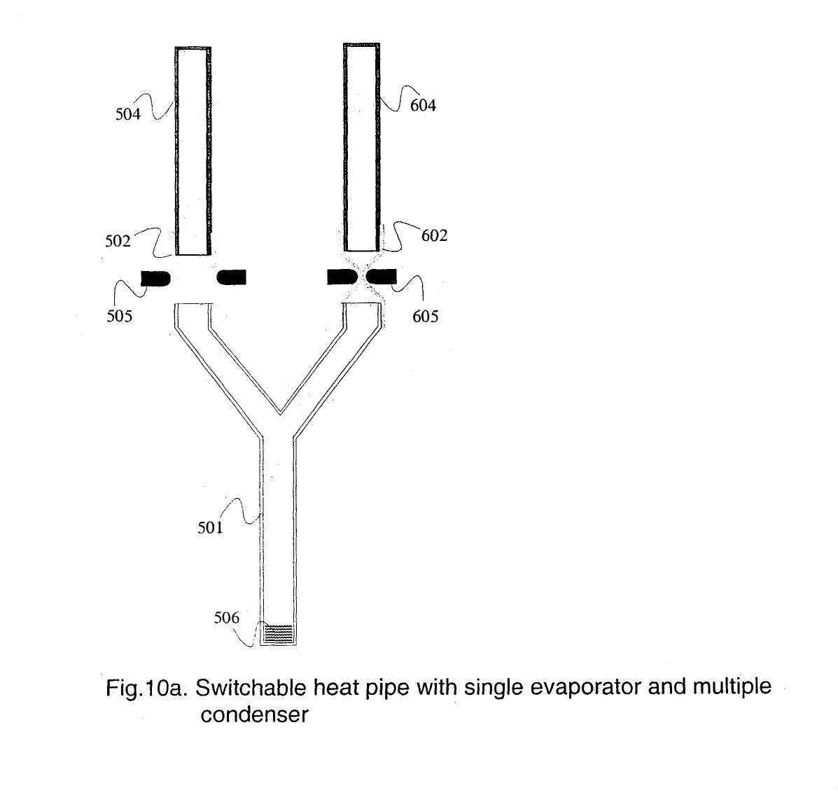

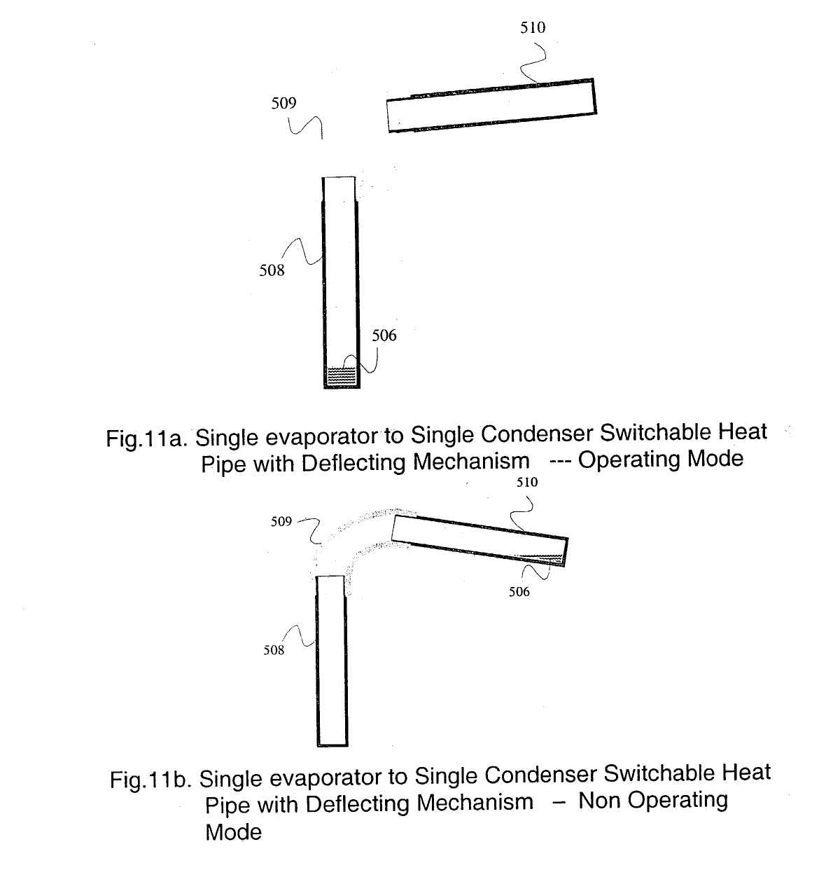

The switchable heat pipes as described in FIG. 10 comprises of

The evaporator and the condenser part of the heat pipe are connected to each other through a squeezable tube/hose.

A single evaporator may be connected to multiple evaporators or vice versa by using multiple squeezable pinchable tubes.

A particular condenser or evaporator is isolated from the remaining condensers and evaporators by simply pinching the corresponding squeezable tube.

Pinching of the tubes may be done using any mechanical means, as desired by the application.

Operation of the controllable heat pump is effected by tilting the condenser “Passages” used for heat transfer in the present adsorption modules are means for transporting heat from the heat source to the module and/or from the module to the heat sink.

### DETAILED DESCRIPTION OF THE INVENTION

FIG. 7 shows the construction of the adsorption module in one of the preferred embodiments. Two tubes of smaller diameter 504, 531 are thermally attached to the containment vessel 550 either by way of continuous line welding or by using thermal paste. The two tubes of smaller diameter 504, 531 act as heat pipes, which are used for supplying and removing the heat from the module. An opening at one end of the containment vessel 550 with an outlet 552 lets the adsorbate flow in and out of the module.

One of the heat pipes 504, 531 acts as the means of transferring the heat to the module 500 and other acts as the means to remove the heat from the module. At any given time, only one of the two heat pipes 504, 531 is active. These heat pipes 504, 531 are in thermal contact with the containment vessel 550 that is achieved by either being in thermal contact with the wall of the containment vessel 550 or any internal partition of the containment vessel 551. As per this the containment vessel wall 550/partition 551 acts as fin leading to increase of the containment vessel surface area that is in contact with the adsorbent. This eliminates the need for separate metal fins, thereby reducing the overall thermal mass of the system. Lower thermal mass is a desirable property in case of applications pertaining to adsorption refrigeration or heat pumps. The design described herein achieves the objective of obtaining high rate of heat transfer along with low thermal mass.

Cross sectional area (CSA) of the containment vessel 550 is determined on the basis of amount of adsorbent to be packed in each module 500. As the “CSA” of the module 500 is increased, the fin effectiveness of the containment vessel wall 550 decreases, which in turn decreases the efficiency of heat transfer from the heat pipes 504, 531 to the adsorption module 500 and vice versa. An optimized “CSA” of the module 500 has to be selected based on the desired cycle time and compactness of the system. An optimum “CSA” needs to be arrived at based on the desired adsorption system compactness and COP. Increasing the number of passages 504, 531 for heat transfer can further increase fin effectivness of the containment vessel wall 550. All “passages” 504 used for supplying heat to the module 500 should preferably be equidistant from each other. Same should be done in case of cooling “passages” 531. Fabrication and type of the heat pipes 504, 531 to be used, is based on the desired capacity of heat transfer.

During operation, working fluid at the hot end takes heat from the surroundings to produce vapour, which is then transported to the cold end. At cold end this vapour is condensed on the walls and the liquid drains back to the lower hot end. Liquid drains back by the help of gravity, in case of gravity assisted heat pipes 504, 531, or through a wick due to capillary action. To facilitate the draining back of the liquid, groves or wick may be provided on the inner side of the heat pipe wall. The two side tubes of smaller diameters function as heat pipes 504, 531 that are used to transfer heat to the adsorption module 500 and remove the heat from the module 500. At any given point of time only one of the two heat pipes 504, 531 is operational. The module wall 550 that is preferably made of high conducting material performs the function of fin attached to the heat pipes 504, 531.

The module design disclosed in this invention may be used in a wide range of applications including purification of gases, separation of gases, removal of contaminants from a gas stream, pressure wing adsorption, catalytic reactions, and removal or supply of heat during the reactions, etc.

In other embodiments, the CSA of the containment vessel 550 may be circular, square, rectangular, elliptical or any shape based on space constraints or the need to increase the surface area of the wall in contact with the adsorbate.

In another embodiment, the “CSA” of the “passages” 504, 531 may be circular, square rectangular, elliptical or any shape governed by the space constraints or the method of fabrication being adopted. The containment vessel 550 along with the “passages” 504, 531 may be extruded with “passages” 504, 531 integrated with the containment vessel wall 550 or partition 551. It would improve the fin effectiveness of the containment vessel walls 550.

In other embodiments, the number of “passages” 504, 531 for supplying and removing heat from the module 500 may be varied depending on the desired heat transfer rate. Increasing the number of “passages” 504, 531 increases the fin effectiveness of the module wall 550, resulting in reduction of time required to transfer the requisite amount of heat to and from the module 500.

In another embodiment, the “passages” 504 for supplying the heat to the module 500 is not necessary as in the case of applications where the module 500 is placed directly at the eye of a solar collector. Under such circumstances heat is supplied to the module 500 directly through radiation and the “passages” 531 are required to ensure removal of the heat from the module 500.

In another embodiment, the “passages” 531 for removal of heat from the module 500 is not necessary as in the case of applications where the module 500 is placed directly in cooling fluid stream. Under such circumstances heat is removed from the module 500 directly through the containment vessel wall 550 and the “passages” 504 are required to supply heat to the module 500.

In one of the embodiments, the “passages” 504, 531 run along the partial complete length of the module 500.

In yet other embodiments, the “passages” 504, 531 may be thermally in contact with the inner side of the containment vessel wall 550.

In one of the embodiments, the “passages” 504, 531 are constructed as “heat pipes”. In another embodiment, electric heater may be thermally in contact with the containment vessel wall 550 or partition 551.

In another embodiments, the “passages” 504, 531 may be press fitted inside/outside the containment vessel wall 550 or partition 551.

FIG. 8 shows the construction of the adsorption module in one of the preferred embodiments. Two tubes of smaller diameter 504, 531 are thermally attached to the containment vessel 550 either by way of continuous line welding or by using thermal paste. The two tubes of smaller diameter 504, 531 act as heat pipes, which are used for supplying and removing the heat from the module. An opening at one end of the containment vessel 550 with an outlet 552 lets the adsorbate flow in and out of the module.

One of the heat pipes 504, 531 acts as the means of transferring the heat to the module 500 and other acts as the means to remove the heat from the module. At any given time, only one of the two heat pipes 504, 531 is active. These heat pipes 504, 531 are in thermal contact with the containment vessel 550 that is achieved by either being in thermal contact with the wall of the containment vessel 550 or any internal partition of the containment vessel 551. As per this the containment vessel wall 550/partition 551 acts as fin leading to increase of the containment vessel surface area that is in contact with the adsorbent. This eliminates the need for separate metal fins, thereby reducing the overall thermal mass of the system. Lower thermal mass is a desirable property in case of applications pertaining to adsorption refrigeration or heat pumps. The design described herein achieves the objective of obtaining high rate of heat transfer along with low thermal mass.

Cross sectional area (CSA) of the containment vessel 550 is determined on the basis of amount of adsorbent to be packed in each module 500. As the “CSA” of the module 500 is increased, the fin effectiveness of the containment vessel wall 550 decreases, which in turn decreases the efficiency of heat transfer from the heat pipes 504, 531 to the adsorption module 500 and vice versa. An optimized “CSA” of the module 500 has to be selected based on the desired cycle time and compactness of the system. An optimum “CSA” needs to be arrived at based on the desired adsorption system compactness and COP. Increasing the number of passages 504, 531 for heat transfer can further increase fin effectivness of the containment vessel wall 550. All “passages” 504 used for supplying heat to the module 500 should preferably be equidistant from each other. Same should be done in case of cooling “passages” 531. Fabrication and type of the heat pipes 504, 531 to be used, is based on the desired capacity of heat transfer.

During operation, working fluid at the hot end takes heat from the surroundings to produce vapour, which is then transported to the cold end. At cold end this vapour is condensed on the walls and the liquid drains back to the lower hot end. Liquid drains back by the help of gravity, in case of gravity assisted heat pipes 504, 531, or through a wick due to capillary action. To facilitate the draining back of the liquid, groves or wick may be provided on the inner side of the heat pipe wall. The two side tubes of smaller diameters function as heat pipes 504, 531 that are used to transfer heat to the adsorption module 500 and remove the heat from the module 500. At any given point of time only one of the two heat pipes 504, 531 is operational. The module wall 550 that is preferably made of high conducting material performs the function of fin attached to the heat pipes 504, 531.

The module design disclosed in this invention may be used in a wide range of applications including purification of gases, separation of gases, removal of contaminants from a gas stream, pressure wing adsorption, catalytic reactions, and removal or supply of heat during the reactions, etc.

In other embodiments, the CSA of the containment vessel 550 may be circular, square, rectangular, elliptical or any shape based on space constraints or the need to increase the surface area of the wall in contact with the adsorbate.

In another embodiment, the “CSA” of the “passages” 504, 531 may be circular, square rectangular, elliptical or any shape governed by the space, constraints or the method of fabrication being adopted. The containment vessel 550 along with the “passages” 504, 531 may be extruded with “passages” 504, 531 integrated with the containment vessel wall 550 or partition 551. It would improve the fin effectiveness of the containment vessel walls 550.

In other embodiments, the number of “passages” 504, 531 for supplying and removing heat from the module 500 may be varied depending on the desired heat transfer rate. Increasing the number of “passages” 504, 531 increases the fin effectiveness of the module wall 550, resulting in reduction of time required to transfer the requisite amount of heat to and from the module 500.

In another embodiment, the “passages” 504 for supplying the heat to the module 500 is not necessary as in the case of applications where the module 500 is placed directly at the eye of a solar collector. Under such circumstances heat is supplied to the module 500 directly through radiation and the “passages” 531 are required to ensure removal of the heat from the module 500.

In another embodiment, the “passages” 531 for removal of heat from the module 500 is not necessary as in the case of applications where the module 500 is placed directly in cooling fluid stream. Under such circumstances heat is removed from the module 500 directly through the containment vessel wall 550 and the “passages” 504 are required to supply heat to the module 500.

In one of the embodiments, the “passages” 504, 531 run along the partial complete length of the module 500.

In yet other embodiments, the “passages” 504, 531 may be thermally in contact with the inner side of the containment vessel wall 550.

In one of the embodiments, the “passages” 504, 531 are constructed as “heat pipes”.

In another embodiment, electric heater may be thermally in contact with the containment vessel wall 550 or partition 551.

In another embodiments, the “passages” 504, 531 may be press fitted inside/outside the containment vessel wall 550 or partition 551.

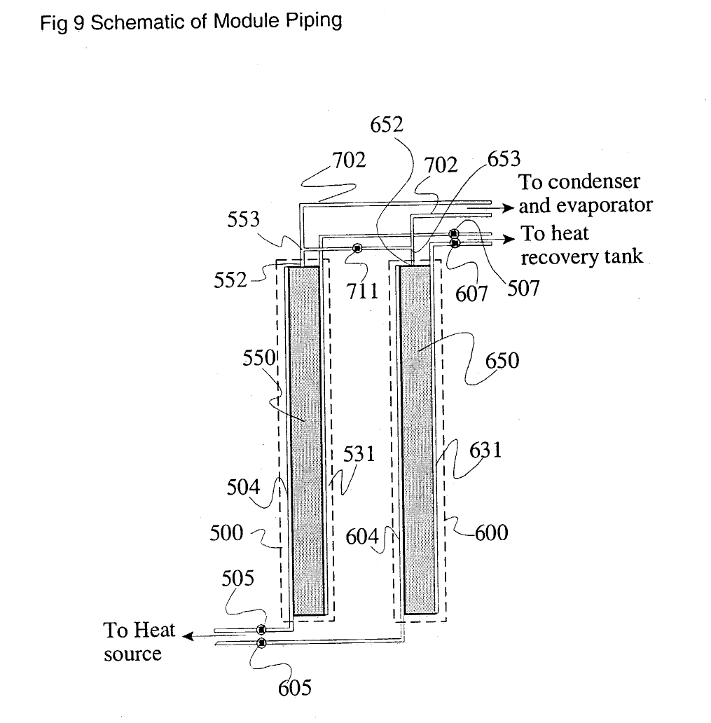

FIG. 9 shows details of the module piping for a set of two modules 500, 600. Each module 500/600 is made up of a containment vessel 550 containing suitable adsorbant and the containment vessel 550 which is in thermal contact with hot end and cold ends of switchable heat pipes. Size and number of such sets may be varied depending on the desired capacity. Module 500 is in thermal contact with hot end 504 and cold end 531 of switchable heat pipe. Similarly module 600 is in thermal contact with hot end 604 and cold end 631 of switchable heat pipe. Either hot or cold end is operational at any instant. The modules 500, 600 are filled with the adsorbent and have outlets 552/652, which has a mesh of suitable density to prevent adsorbent particles from escaping along with the refrigerant. This exit has a three-way connector 553, 653. One side is used for connecting the two modules through a valve 711 and the other side 702 leads to the condenser and evaporator. Incorporation of plurality of modules enables continuous cooling and heating effect.

Two adsorption modules 500, 600 are connected through valve 711 to allow pressure equalization between the two adsorption modules 500, 600, at end of generation and/or adsorption phases. The refrigeration sub-system operates on an adsorption refrigeration cycle with pressure equalization for heat recovery. The two module operate out of phase, i.e. one module is being heated while the other is being cooled. During pressure equalization between two modules or two sets of modules, refrigerant from a module or a set of module at high pressure is allowed to flow to a module or a set of modules at relatively lower pressure. This method of regeneration between two modules or sets of modules reduces the requirement of heat input from the external heat source in the generation phase and thus increases COP.

Pressure equalization between two sets of modules single stage pressure equalization. Multi-stage pressure equalization is achieved if pressure equalization is effected sequentially between three or more modules or sets of modules. Vapour and heat regeneration efficacy increases with increase in number of stages of regeneration. Multi-stage regeneration eliminates the need for heat transfer fluid loops and the associated complex valve arrangements and controls otherwise needed for regeneration. Vapour equalisation technique enhances COP of the system and also reduces cycle time. Cycle time is reduced because the time required to equalize pressure is a fraction of the time required to regenerate the heat using heat transfer fluid loops. Also the auxiliary power required to pump the heat transfer fluids is eliminated.

Adsorption modules 500, 600 used in refrigeration cum heating system, are shown in FIG. 7. The thermal bonding between adsorption module and hot/cold ends can be achieved by co-extruding the three tubes or by welding the two smaller diameter pipes to the main module tube or by any other suitable means.

The module design may be further modified based on the application requirements. Shape of module and-the heat pipes may be varied on the basis of the ease of fabrication or other application constraints. Diameters of the module and heat pipe are governed by the desired capacities. Number of heat pipes of each type can be varied to increase or decrease the heat transfer rate. In some cases, the heat pipes either for heating or cooling are not required. Due to some constraints, it might not be possible to make the heat pipe run along the complete length of the module. Heat pipes may be thermally affixed on the inner side of the module wall, or they may be co-extruded along with the main pipe or affixed by any other means. But the basic idea of using the heat pipes for supplying and removing the heat from the adsorption modules, and integrating the same with the walls of the module to avoid the need of separate fins to facilitate heat transfer within the adsorbent bed still holds. In this design the wall of the module acts as a fin to facilitate heat transfer thereby reducing the overall thermal mass of the system, leading to lower cycle times and higher COP.

Hot/cold ends 501, 534, 504, 531, 604, 631 of switchable heat pipes, used in refrigeration cum heating system, use a system to isolate hot end from cold end or vice versa. FIG. 10 shows switchable heat pipes, which comprises hot end, evaporator 501 and cold end, condenser 504, flexible tube 502 and-pincher 505. The heat receiving section is integrated into the heat source and the heat giving section is integrated into the heat sink. When the heat pipe is in operation, the flexible tube is in the un-pinched position. Fluid in the hot end 501 evaporates absorbing heat from the heat source and passes to the cold end 504 and/or 604 passing through the flexible tube 502 and/or 602. In the cold end these vapours condense, delivering the heat. The condensate is transferred back to the hot end 501 due to capillary action of the wick or it drains back due to the gravitational action. To switch off the heat pipe, the flexible tube 502, 602 is pinched using the pinchers 505, 605, 507, 607. This isolates the hot end 501 and the cold end 504 and the heat pipe ceases to operate.

This novel construction and arrangement gives this heat the flexibility to use it in diverse ways. Heat pipe cross-section used may be of any shape (such as circular, elliptical, rectangular, etc.). Cross-sectional area of the heat pipe is decided on the basis of the desired capacity of heat transfer. The flexible tube used to connect the heat receiving section and the heat giving section can be made of any material as long as it can be pinched/squeezed to isolate the two sections as long as the material of the flexible tubing is compatible with the fluid used in the heat pipe. A wick may be provided on the inner wall of the heat receiving section, heat giving section and flexible tubing to facilitate the draining back of the fluid. There is no restriction on the type of wick that should be used, except that in the flexible tube section the wick should be also flexible. A sealant has to be applied to seal the flexible tube and metal tube joints. Sealant should be able to withstand pressures at which heat pipe is supposed to operate. Any material may be used for making the heat receiving or condenser sections 501, 504 of the heat pipe as long as it is compatible with the working fluid. Any pinching mechanism may be used to pinch the flexible tube 502 depending on the application.

In refrigeration cum heating system, as shown in FIG. 7, the design of the evaporator 707, condenser 703 and the heat recovery tank 709 may vary as per the application, location, etc. Purpose of the heat recovery tank is to recover the heat released from the adsorption modules 500, 600 during the adsorption phase and use it for heating purposes. Heat is being transferred from the adsorption modules to the heat recovery tank 709 using the heat pipes 504, 531, 604, 631. Each heat recovery tank 709 will have heat pipes coming from at least two adsorption modules 500, 600 and each heat pipe 504, 531, 604, 631 would be operational during the adsorption phase of the respective module. Condenser 703 shown in FIG. 1 is an evaporative condenser. Design of the same will depend on space and location constraints. Each condenser should condense refrigerant coming through at least two adsorption modules during the generation phase but only one of them is operational at any given time. These will then lead to the evaporator 707, which has to be customized for a particular application like for chilling water, for producing ice or for cold storages, etc.

The system described in this invention may also function without pressure equalisation. In such cases the COPs obtained will be low, as compared to the system operating with heat regeneration as described above.

FIG. 10 shows the design of the disclosed heat pipe for simplest application, i.e. transferring heat from one source to one receiver. It comprises an evaporator 501, condenser 504, squeezable tube 502 and pincher 505. The evaporator 501 is integrated into the heat source and the condenser 504 is integrated into the heat sink. When the heat pipe is in operation, the squeezable tube 502 is in the un-pinched position. Fluid 506 in the evaporator 501 evaporates taking heat from the heat source and moves to the condenser 504 passing through the squeezable tubing. In the condenser 504 these vapors condense, giving away their heat and drain back due to gravity in the evaporator 501. To switch off the heat pipe, the squeezable tube 502 is pinched using the pinchers 505. This isolates the evaporator 501 and the condenser 501 and the heat pipe seizes to operate. The amount of fluid 506 in the heat pipe is determined based on the desired operating temperature level of the heat pipe. Beyond this temperature limit, fluid 506 exists in vapour state and there is no condensation in 504 hence no evaporation in 501. Thus the heat pipe seizes to operate at and above this temperature. The simple pinchable heat pipe design is easy to operate and several heat pipes can be controlled using a single rotating shaft with appropriate cams to push the pinchers. This effective heat pipe design will be low in cost and is suitable for applications where a very large number of independent loads are to be switched on and off.

FIG. 10 shows example of a heat pipe that can be used for transferring the heat from a single source to multiple receivers, either simultaneously or one at a time. It has two condensers 504 and 604, one evaporator 501 and two pinchers 505 and 605, one for each condenser. To deactivate a particular condenser, the corresponding pincher is used to pinch the squeezable tube. In order to completely switch off the heat pipe, both pinchers are pinched simultaneously. This heat pipe is an effective solution to alternate or sequence heating of two loads.

FIG. 10 gives an example of a heat pipe that can be used for transferring heat from multiple source to single receiver, either simultaneously or from one evaporator at a time. It has two evaporators 531 and 631, one condenser 534, and two pinchers 507 and 607, one for each evaporator. To deactivate a particular evaporator, the corresponding pincher is used to pinch the squeezable tube. In order to completely switch off the heat pipe, both the pinchers are pinched simultaneously. A sealant has to be applied to seal the squeezable tube and metal tube joints. Sealant should be able to withstand pressures at which heat pipe is supposed to operate. This heat pipe is an effective solution to alternate or sequence cooling of two loads.

FIG. 10 gives an example of a switchable heat pipe without pinching means consisting of evaporator 501 and condenser 504. The evaporator 501 and condenser 504 may be a continuous rigid tube capable of bending. Optionally squeezable tube 502 connects evaporator 501 and condenser 504. Heat pipe is controlled by retaining fluid in liquid state in the condenser thereby depriving the evaporator from access to this fluid. Heat transfer rate using the heat pipe and the cut out temperature at which the heat pipe stops transferring heat is controlled by tilting the condenser and retaining fluid in liquid state. Condenser 504 can be tilted using suitable means. This means and method of control of heat transfer rate is ideal for low cost applications.

This novel construction and arrangement provides flexibility to use it with diverse systems as listed below:

a. Heat pipe cross-section used may be of any shape (like circular, elliptical, rectangular, etc.)

b. The squeezable tube used to connect the evaporator and condenser can be made of any material as long as it can be pinched/squeezed to isolate the two section as long as the material of the squeezable tubing is compatible with the fluid used in the heat pipe.

c. Number of evaporators and condensers used in each heat pipes may be varied as desired by the application.

d. A wick may be provided on the inner wall of the evaporator, condenser and squeezable tubing to facilitate the draining back of the fluid. There is no restriction on the type of wick that should be used, except that in the squeezable tube section the wick should be also squeezable.

e. Any material may be used for making the evaporator or condenser sections of the heat pipe as long as it is compatible with the working fluid.

f. Any pinching mechanism may be used to pinch the squeezable tube depending on the application.

g. The evaporator and condenser may be a continuous rigid tube capable of bending enabling control of heat transfer rate and maximum operating temperature.

The invention is now illustrated with non-limiting examples.

### EXAMPLES

A preferred embodiment of the Energy efficient regeneration process is illustrated with a non-limiting example.

### Example 1

A two-stage regenerator device was fabricated and tested for regeneration of calcium chloride LD. It comprises a HTR made of aluminium rectangular channel in which electrical heaters are incorporated as heat-source. LTR incorporates the aluminium disks are of 150 mm diameter, with circumferential lip and dimples as the contacting device between LD and ambient air. The disks are mounted on an aluminium shaft of diameter 9.5 mm. The disks are placed in a semi hexagonal aluminium trough 500 mm (length)×200 mm (width)×210 mm (height). It incorporates 337 m²/m³ surface density, when maintaining 5 mm gap between the disks using plastic spacers. Contacting device is covered with a hood and a chimney of diameter 100 mm, length 1.5 m. Airflow through the contacting device is due to natural convection induced by the chimney effect. The disks are made to rotate at 5 rpm using an electric motor. Inlet and out let of LD to the trough is through 9.5 mm diameter aluminium tubes. The experimental result in Table 1, shows that the regenerator is capable of removing 2.6 kg/kW-h water from calcium chloride LD. It is observed that there is no carry over of LD with air stream and along the condensate collected from LTR.

TABLE 1
Experimental Result for Regeneration of Calcium Chloride
Liquid Desiccant with Two-Stage Regenerator

| | | Ambient air | | | Chimney air | | | | |
|---|---|---|---|---|---|---|---|---|---|
| Q | Mfw | DBT | WBT | RH | DBT | WBT | RH | V | |
| kW | kg/h | ° C. | ° C. | % | ° C. | ° C. | % | m/s | Remarks |
| 8 | 21 | 26.6 | 19 | 47 | 60 | 58 | 82 | 2 | No carry |
| | | | | | | | | | over of LD |

Q Electric heat input
DBT Dry bulb temperature,
RH Relative humidity
mfw Total water removed from LD
WBT Wet bulb temperature
V Velocity of air at exit

The other associated advantages of this two stage/multistage regeneration process are, no corrosion, no orifices or nozzles to wear or clog, modular system that can be installed with flexibility, silent operation without splashing or spraying sounds and low electrical power consumption.

The invention is now illustrated with a non-limiting example.

### Example 2

### Humidification of Air Using Contacting Device

The contacting device was fabricated and tested for humidification of ambient air. It comprises discs made of aluminium mesh. The discs are of 150 mm diameter, with circumferential lip and dimples. The discs are mounted on an aluminium shaft of diameter 9.5 mm. The discs are placed in a semi hexagonal aluminium trough 500 mm (length)×200 mm (width)×210 mm (height). It incorporates 337 m²/m³ surface density, when maintaining 5 mm gap between the discs using plastic spacers. Contacting device is covered with a hood and a chimney of diameter 100 mm, length 1.5 m. Airflow through the contacting device is due to natural convection induced by the chimney effect. The discs are made to rotate at 5 rpm using an electric motor. Inlet and out let of water to the trough is through 9.5 mm diameter aluminium tubes. The experimental result in Table 2 shows that the contacting device efficiency for humidification of air is as high as 98% for the ambient conditions are 26.8° C. and 48% relative humidity. It is observed that there is no carry over of liquid with air stream.

TABLE 2
Experimental Result for Humidification of Air Using Contacting
Device

| Ambient air | | | Chimney air | | | |
|---|---|---|---|---|---|---|
| DBT | WBT | RH | DBT | WBT | RH | |
| ° C. | ° C. | % | ° C. | ° C. | % | Remarks |
| 26.8 | 19.5 | 48 | 58 | 57.6 | 98 | No carry over of |
| | | | | | | liquid with air |

DBT Dry bulb temperature,
WBT Wet bulb temperature
RH Relative humidity

The other associated advantages of this contacting device are, no corrosion, no pumps, no tubes, no orifices or nozzles to wear or clog, modular system that can be installed with flexibility, silent operation without splashing or spraying sounds and low electrical power consumption.

### Example 3

### Results of CaCl₂ using Hybrid Cooling System

A hybrid cooling system is designed with the following specification:

| a. | Evaporator duty | | 3.52 kW (1 TR) |
|---|---|---|---|
| b. | CaCl₂ solution temperatures | | |
| | i. | Condenser inlet | 45.9° C. |
| | ii. | Condenser outlet | 49° C. |
| | iii. | Evaporator inlet | 24.1° C. |
| | iv. | Evaporator outlet | 20° C. |

| | | |
|---|---|---|
| c. | Evaporator exit superheat | 5° C. |
| d. | Condenser exit sub-cooling | 0° C. |
| e. | Condenser temperature | 51° C. |
| f. | Evaporator temperature | 15° C. |
| g. | Compressor isentropic efficiency | 80% |
| h. | Hermetic compressor motor efficiency | 84% |
| i. | Ratio of clearance to swept volume | 5% |

The salient features of the model are as follows:

a. The model is developed for the design of a HCS with single stage VCRS

b. A liquid-vapour heat exchanger/refrigerant sub-cooler may be incorporated on the refrigerant side to further improve the capacity and COP of the HCS.

c. A liquid-liquid heat exchanger/solution heat exchanger is also designed on CaCl₂ solution streamside for energy saving and for enhancing the overall system COP and capacity.

h. The relevant simulated results are given in Table 3.

TABLE 3
Comparison of the Values of the Results between the Novel HCS
and a Conventional VCRS.

| Parameters | VCRS | Novel HCS | % Change | |
|---|---|---|---|---|
| Pressure ratio | 3.66 | 2.52 | 31 | decrease |
| Compressor displacement, | 1.13 | 0.79 | 30 | decrease |
| litre/s | | | | |
| Swept Volume, litre/s | 1.626 | 1.01 | 37.8 | decrease |
| Compressor Work, kW | 1.23 | 0.83 | 32.5 | decrease |
| Cooling Capacity, TR | 1.0 | 1.6 | 60 | increase |
| COP | 2.85 | 4.14 | 45 | increase |
| Volumetric Efficiency | 87 | 92 | 6 | increase |

The main advantages of the system are the significantly improved energy efficiency, zero carryover of LD into process air streams, increase in cooling capacity for a given compressor in comparison to the conventional HCS using “packed” or “spray type-contacting devices”. This is possible with the appropriately designing of the absorber, regenerator, liquid-liquid heat exchanger and other components of HCS. Significant reduction in weight and cost is achieved with the use of alternate materials such as plastics and eliminates any problems due to corrosion of the absorber/regenerator as in conventional systems. The contacting media disclosed in this invention offers high surface densities as high as 600 m²/m³, which is about 185% greater than conventional packing. The system is compact, lower weight and techno-economically viable for air-conditioning.

### Example 4

In order to establish the performance of the adsorption module, its performance has been evaluated for example in a model adsorption refrigeration system.

Some of the important parameters that are considered fixed for the model system are as follows:

| | |
|---|---|
| 1. Evaporator temperature | −5° C. |
| 2. Generator outlet temperature | 199° C. |
| 3. Adsorber outlet temperature | 40° C. |
| 4. Maximum pressure in module | 23 bar |
| 5. Pressure factor of safety | 1.5 |
| 6. Intensity of solar radiations | 750 W/m² |
| 7. Duration for which radiation is available | 6 hrs |
| 8. Efficiency of solar collector | 45% |
| 9. Dry bulb temperature | 30° C. |
| 10. Wet bulb temperature | 22° C. |
| 11. Minimum wall thickness | 1 mm |
| 12. Diameter of Heat pipes | 6.35 mm |

The findings are:

a. As the module diameter increases the COP of the system increases and the SCP decreases. Significantly high values of SCP, up to 400 W/kg of adsorbent are achieved.

b. SS304 has conductivity of the order of 17.7 W/m ° K., and Al has conductivity of the order of 210 W/m ° K. Aluminium gives a much higher COP in comparison to Stainless Steel. Due to high conductivity of Al, the fin effectiveness of the module wall is significantly increased. This leads to a lower time required to transfer the desired amount of heat from heat pipe to the adsorption module and vice versa, which in turn leads to a lower cycle time. Also due to lower cost of Al, the contribution of the refrigeration sub-system cost decreases significantly, which in turn leads to a lower overall system cost.

c. Increasing the number of heat pipes each for supplying and removing the heat from the module decreases the cycle time leading to higher COP.

The system disclosed in the invention clearly brings out the advantages over the prior art in terms of the following:

a. High Coefficient of Performance (COP) up to 0.9, due to low thermal mass, which is the result of elimination of need for separate metallic fins.

b. Simple design, which is easy to manufacture, leading to low cost

c. High Specific cooling power in the range of 50 to 750 W/kg of adsorbent, which is just 20 to 40 W/kg of adsorbent in case of prior art.

### Example 5

The results of an adsorption refrigeration cum heating system, using adsorption cycle with pressure equalisation for heat regeneration, with activated carbon/ammonia as working adsorbent—adsorbate pair are given to serve as a non-limiting example of the present invention.

Table 4 presents the simulation results for a system using solar collector as the heat source. Some of the important parameters that are considered fixed for the system in this example for simulation are as follows:

| | |
|---|---|
| 13. Evaporator temperature | −5° C. |
| 14. Generator outlet temperature | 199° C. |
| 15. Adsorber outlet temperature | 40° C. |
| 16. Maximum pressure in module | 23 bar |
| 17. Pressure factor of safety | 1.5 |
| 18. Intensity of solar radiations | 750 W/m² |
| 19. Duration for which radiation is available | 6 h |
| 20. Efficiency of solar collector | 45% |
| 21. Dry bulb temperature | 30° C. |
| 22. Wet bulb temperature | 22° C. |
| 23. Minimum wall thickness | 1 mm |
| 24. Diameter of Heat pipes | 6.35 mm |
| 25. Shape of Module | Circular |
| 26. Shape of Heat pipes | Circular |

TABLE 4
Simulation results for an optimised system using solar
collector as heat source.

| | Module | | | | | |
|---|---|---|---|---|---|---|
| | Diameter | No. of | | Cycle Time | SCP | Weight of ice |
| Material | (mm) | heat pipes | COP | (min) | (W/kg) | (kg/m².day) |
| Aluminium | 38.1 | 1 | 0.40 | 57.7 | 162 | 6.574 |
| SS 304 | 38.1 | 1 | 0.38 | 34.9 | 143 | 6.143 |
| Aluminium | 38.1 | 2 | 0.39 | 16.0 | 312 | 6.303 |

Though this system can operate with various heat sources, one of the very common applications of the adsorption systems is solar refrigeration. Solar refrigeration is an important use of solar energy because the supply of solar energy and the demand for cooling are greatest during the same season. It has the potential to improve the quality of life of people who live in areas where the supply of electricity is far from sufficient. The success of solar cooling is dependent on the availability of low cost and high performance of solar collectors. In the disclosed refrigeration cum heating system if solar energy is used as the input, solar collector contribute to more then 80% of the system cost. Still the costs have been brought down significantly by reducing the solar collector area required per kg of ice produced per day and the cost of adsorption modules. This has been made possible in the present invention due to high COP of the system with low cycle time. After optimizing the system to minimize the system cost the overall system is expected to cost one-third of the currently commercially available solar refrigeration system. In addition to that system is very compact and gives hot water as an additional utility.

We claim:

1. Novel energy efficient multi-stage regeneration processes, for regenerating liquid desiccant (LD), using rotating contacting disks assembly to provide intimate contact between LD and vapour/gas to enhance the interfacial area between them for increased heat and/or mass transfer, without problems of carryover of liquid in to the vapour/gas stream or flooding, having the provision to efficiently heat and/or cool the liquid while cooling and dehumidifying the air using a Hybrid Cooling System (HCS).

2. An energy efficient multi-stage regeneration process (EEMSRP) for regenerating liquid desiccant (LD) as claimed in claim 1 further comprising:
Partial or complete regeneration of LD in a Low Temperature Regenerator (LTR)
Partial or complete regeneration of LD in a Intermediate Temperature Regenerator (ITR)
Partial or complete regeneration of LD in a High Temperature Regenerator (HTR)
desuperheating of vapour generated in HTR in a heat exchanger (HTRHE) while preheating the LD before entering HTR
subcooling of LD regenerated in HTR in HTRHE while preheating the LD before entering HTR
condensation of desuperheated vapour from HTRHE in heat exchanger inside ITR while regenerating LD
desuperheating of vapour generated in ITR in a heat exchanger (ITRHE) while preheating the LD before entering ITR and/or HTR
subcooling of LD regenerated in ITR in ITRHE while preheating the LD before entering ITR and/or HTR
subcooling of condensate from ITR in ITRHE while preheating the LD before entering ITR and/or HTR
desuperheating of vapour generated in ITR in a ITRHE while preheating the LD before entering ITR and/or HTR
condensation of desuperheated vapour from ITRHE in “passages” thermally in contact with LTR while regenerating LD
flowing of vapour/gas through LTR with the aid of and arrangement such as chimney/fan to pickup the vapours from LD
subcooling of LD regenerated in LTR in LTRHE while preheating the LD before entering LTR and/or ITR and/or HTR
subcooling of condensate from LTR in LTRHE while preheating the LD before entering LTR and/or ITR and/or HTR wherein the number of stages in the regeneration process is (2+n) where n is the number of ITR's in the process.

3. The EEMSRP claimed in claim 1 is a two-stage regeneration process involving a HTR and LTR without involvement of ITRs.

4. A two-stage regeneration process claimed in claim 3 comprising:
partial or complete regeneration of LD in a LTR
Partial or complete regeneration of LD in a HTR
desuperheating of vapour generated in HTR in HTRHE while preheating the LD before entering HTR
subcooling of LD regenerated in HTR in HTRHE while preheating the LD before entering HTR
Condensation of desuperheated vapour from HTRHE in “passages” thermally in contact with LTR while regenerating LD
Flowing of vapour/gas through LTR with the aid of chimney/fan to pickup the vapours from LD
subcooling of LD regenerated in LTR is in LTRHE while preheating the LD before entering LTR and/or HTR
subcooling of condensate from LTR is also in LTRHE while preheating the LD before entering LTR and/or HTR.

5. A two-stage regeneration process claimed in claim 1 wherein weak LD from the source is pumped and preheated through LTRHE then it is further preheated through HTRHE and partially regenerated in HTR thereafter subcooled in HTRHE before being throttled into LTR where it is fully regenerated and then subcoled in LTRHE and returned to the source.

6. A two-stage regeneration process claimed in claim 1 wherein weak LD from the source is pumped and preheated through LTRHE then partially regenerated in LTR and pumped through HTRHE where it is preheated before entering HTR where it is fully regenerated and then subcoled in HTRHE and LTRHE before being returned to the source.

7. A two-stage regeneration process claimed in claim 1 wherein weak LD from the source is pumped and preheated through LTRHE after which part of the LD flow is throttled into the LTR and fully regenerated and the other part of the LD flow is preheated through HTRHE on its way to HTR where it is fully regenerated and then subcoled in HTRHE before being combined with the fully regenerated LD stream from LTR and then subcooled in LTRHE before being returned to the source.

8. A two-stage regeneration process claimed in claim 1 wherein vapour generated in HTR is desuperheated in HTRHE and the desuper heated vapour is condensed in “passages” thermally in contact with LTR and the condensate from LTR is then subcooled in LTRHE

9. The EEMSRP claimed in claim 1 may be a three-stage regeneration process involving a HTR, LTR and one ITR.

10. A three-stage regeneration process claimed in claim 1 wherein weak LD from the source is pumped and preheated through LTRHE and ITRHE then it is further preheated through HTRHE and partially regenerated in HTR thereafter it is subcooled in HTRHE and throttled into the ITR where it is regenerated further and them subcooled in ITRHE before being pumped into LTR where it is fully regenerated and then subcoled in LTRHE and returned to the source.

11. A three-stage regeneration process claimed in claim 1 wherein weak LD from the source is pumped and preheated through LTRHE and partially regenerated in the LTR then pumped through ITRHE where it is preheated before it is regenerated further in ITRHE then this partially regenerated LD is pumped through the HTRHE where it is preheated through HTRHE and regenerated further in HTR thereafter the fully regenerated LD is subcooled in HTRHE, ITRHE and LTRHE and then pumped back to the source.

12. A three-stage regeneration process claimed in claim 1 wherein weak LD from the source is pumped and preheated through LTRHE after which part of the LD flow is throttled into the LTR and fully regenerated and the other part of the LD flow is preheated through ITRHE after which part of the LD flow is throttled into the ITR where it is fully regenerated and the third part of the LD flow is preheated through HTRHE on its way to HTR where it is fully regenerated and then subcoled in HTRHE after which it is combined with the LD flow from the ITR and then subcooled in ITRHE before being combined with the fully regenerated LD stream from LTR and finally it is subcooled in LTRHE before being returned to the source.

13. A three-stage regeneration process claimed in claim 1 wherein vapour generated in HTR is desuperheated in HTRHE and condensed in ITR and further subcooled in ITRHE before throttling it into the desuperheated vapour generated in ITR this liquid vapour stream is then condensed in “passages” thermally in contact with LTR and the condensate from LTR is then subcooled in LTRHE before being pumped out.

14. An energy efficient multi-stage regeneration process (EEMSRP) for regenerating liquid desiccant (LD) comprising:
HTR operating at highest pressure in the system boiling the weak LD absorbing heat from an external source, having insulation on exposed surface to avoid heat loss from LD to surroundings and giving off vapour to next relatively low temperature ITR, in which the latent heat of vapour generated in HTR is used to boil the LD.
ITR operating at a particular pressure heated using the vapour generated in the ITR/HTR operating at next higher-pressure level wherein the vapour generated in the ITR is passed on to the next ITR/LTR operating at next lower pressure level.
A LTR, operating at atmospheric pressure, incorporating large surface density contacting device, having provision to heat the LD, with vapour generated in immediate higher temperature HTR/ITR condensing in the passages, in thermal contact with a container such as a the containing the LTR
Optional arrangement such as a hood with chimney to aid the flow of ambient air through LTR to pickup the moisture from LD.
A device to rotate/oscillate the contacting discs assembly in the LTR
Optional heat exchangers HTRHE, ITRHE and LTRHE used to recycle heat to enhance the energy efficiency of the process
Pressure reducing devices such as throttle valve
Liquid desiccant pump(s)
wherein the number of stages in the system for regeneration is (2+n) where n is the number of ITR's in the process.

15. A system for energy efficient single stage regeneration process for regenerating liquid desiccant (LD) as claimed in claim 14 comprising:
LTR, incorporating large surface density contacting device, having provision to heat the LD using heat from an external source in passages which are in thermal contact with a container such as a trough containing the LTR
Optional arrangement such as a hood with chimney to aid the flow of ambient air through LTR to pickup the moisture from LD.
A device to rotate/oscillate the contacting discs assembly in the LTR
Optional heat exchanger used to recycle heat to enhance the energy efficiency of the process
Liquid desiccant pump.

16. Novel contacting device providing intimate contact between fluids to enhance the interfacial area between them comprising:
assembly of contacting discs
shaft for mounting the contacting discs for increased heat and/or mass transfer
device for rotating/oscillating the contacting discs assembly trough to hold fluids in which the disc assembly is partially or fully submerged
passages in thermal contact with a trough
optional device to induce vapour/gas flow optional enclosure with arrangement to guide the flow of vapour/gas.

17. Contacting disc claimed in claim 16 is a mesh, plain/roughened surface or porous material.

18. Contacting disc claimed in claim 16 is of any shape preferably circular.

19. Contacting disc claimed in claim 16 is of any material including metal, plastic, ceramic, alloys, depending on the end use of the device.

20. Contacting disc in the assembly claimed in claim 16 has circular or preferably non-circular hole on the surface for shaft mounting.

21. Contacting disc claimed in claim 16 optionally having lipping.

22. Assembly of contacting discs of similar or dissimilar types as claimed in claim 16 mounted on a solid or hollow shaft of any appropriate material.

23. Contacting discs as claimed in claim 16 having dimples/projections at least on one of its surface functioning as spacers in a disc assembly.

24. The shaft claimed in claim 16 is a rod, tube with or without internal passages for fluid flow.

25. Contacting discs as claimed in claim 16 without dimples/projections mounted with spacers on a shaft.

26. Contacting disc assembly as claimed in claim 16 fixed or thermally bonded to a shaft.

27. Device for rotating/oscillating the contacting discs assembly as claimed in claim 16 capable of rotating the assembly preferably at 3 to 5 rpm or oscillating it through angles greater than 300 in either direction.

28. A trough of any material, shape and size to match the assembly of 16.

29. Heat exchanging passages claimed in claim 16 is a coil, or multiplicity of tubes of any material in thermal britact with the inner or outer surface of the trough or integrated into the trough.

30. Contacting device as claimed in claim 16 without carryover of fluid into the vapour/gas stream or flooding with provision for heating/cooling the liquid depending on the application of the device.

31. Contacting device as claimed in claim 16 with surface density in the range of about 450 to about 600 m²/m³ operating at pressure drop across the contacting device to as low as about 5 Pa.

32. A contact device as claimed in claim 16 with no limit on liquid throughput leading to high efficiency of the process and operating with low power consumption of around 3 to 10 W per 50 to 100 m³/h volume flow rate of vapour/gas.

33. A contact device as claimed in claim 16 in combination with appropriate devices used for applications involving dehumidification, humidification, cooling towers, air-conditioning.

34. A contact device as claimed in claim 16 for applications involving separation of gases from the liquid, regeneration of liquid desiccants, distillation columns, rectification columns, absorption refrigeration systems, multiphase-multicomponent adiabatic/non-adiabatic chemical/bio reactors, and cold/heat storage applications.

35. Contacting device as claimed in claim 16 for humidification or cooling and dehumidification with efficiencies up to 98%.

36. A hybrid cooling system, in which air temperature and humidity are simultaneously controlled, comprising;
An absorber/Indoor Contacting Device (ICD), for dehumidifying air by bringing it in contact with-the LD while being cooled by evaporating refrigerant in the integrated evaporator
A regenerator/Out Door Contacting Device (OCD) for regenerating LD by bringing it in contact with air, while LD being heated by condensing refrigerant in the integrated condenser
A refrigerant compressor, to compress the refrigerant vapour coming from absorber/ICD after absorbing heat from LD and to send the high pressure refrigerant vapour to regenerator/OCD for delivering heat to the LD
A throttling device, for throttling liquid refrigerant moving from regenerator/OCD to absorber/ICD
Optional liquid-liquid heat exchanger, to recycle heat from the hot regenerated strong LD flowing from the regenerator/OCD into the weak LD pumped out of the absorber/ICD
Two optional LD pumps to pump the LD, one from the absorber/ICD to regenerator/OCD and the other from the regenerator/OCD to absorber/ICD
Optional refrigerant liquid to vapour heat exchanger to sub cool the liquid refrigerant coming out of the condenser using the cooling effect of refrigerant vapour coming out of the evaporator
Optional Spiral Contacting Device (SCD) incorporated by the absorber/ICD and regenerator/OCD
Optional external refrigerant evaporator/LD cooler instead of integrated evaporator with absorber/ICD
Optional external refrigerant condenser/LD heater instead of integrated condenser with regenerator/OCD
Optional device to circulate the indoor air through the absorber/ICD and outdoor air through regenerator/OCD and
Optional duct mounting of absorber/ICD and regenerator/OCD.

37. An absorber/ICD claimed in claim 36 is coupled with an evaporator of VCRS.

38. An absorber/ICD claimed in claim 36 is an adiabatic contacting device with a separate heat exchanger to cool the LD.

39. An absorber/ICD and/or regenerator/OCD claimed in claim 36 incorporates large surface density rotating contacting disc assembly as the contacting media between air and LD.

40. An absorber/ICD and/or regenerator/OCD claimed in claim 36, wherein the rotating disc is a mesh, plain/roughened surface or porous material and their like constructed of materials such as a plastic or any other suitable material, which is compatible with LD and air.

41. An absorber/ICD and/or regenerator/OCD claimed in claim 36, wherein the contacting disc assembly is partially submerged in the LD.

42. A contacting disc assembly absorber/ICD and regenerator/OCD as claimed in 39 is rotated at low rpm in the LD, preferably at around 3 to 5 rpm or oscillated to an angle greater than 30° in either direction.

43. A contacting disc assembly in the absorber/ICD and/or regenerator/OCD claimed in claim 36 is mounted in a trough or any suitable container constructed of thermal conducting material.

44. A contacting disc assembly in the absorber/ICD and/or regenerator/OCD claimed in claim 36 is mounted in a trough or any suitable container constructed of non conducting material with wall thickness of <0.2 mm and to withstand the pressure of the heat transfer fluid.

45. An absorber/ICD and/or regenerator/OCD claimed in claim 36, optionally incorporates SCD as the contacting media between the LD and air.

46. A SCD in the absorber/ICD and/or regenerator/OCD claimed in claim 36, is a mesh, plain/roughened surface or porous material and their like constructed of material such as plastic or any other suitable material which is compatible with LD and air.

47. A SCD in the absorber/ICD and/or regenerator/OCD claimed in claim 45 is partially submerged in the LD.

48. A SCD in the absorber/ICD and/or regenerator/OCD claimed in claim 45 is rotated at low rpm in the LD, preferably at around 3 to 5 rpm or oscillated to an angle greater than 30° in either direction.

49. A SCD in the absorber/ICD and/or regenerator/OCD claimed in claim 36 is mounted in a trough or any suitable container without passages.

50. A trough claimed in claim 49 constructed of conducting/non conducting material without limitation of wall thickness.

51. An absorber/ICD claimed in claim 36 comprises passages wherein the evaporation of the refrigerant takes place, are in thermal contact with the trough of absorber/ICD.

52. Passages of the absorber/ICD claimed in claim 51 are inside or outside or integrated into the trough of absorber/ICD.

53. Passages of the absorber/ICD claimed in claim 52, wherein the chilled fluid is flowing through the passages instead of evaporating the refrigerant.

54. A regenerator/OCD claimed in claim 36, comprises the passages wherein the condensation of the refrigerant takes place, are in thermal contact with the trough of the regenerator/OCD.

55. Passages of the regenerator/OCD claimed in claim 54 is inside or outside or integrated into the trough of the regenerator/OCD.

56. Passages of the regenerator/OCD claimed in claim 55, where in a hot fluid is flowing through the passages instead of condensing refrigerant.

57. The circulating device in the absorber/ICD and/or regenerator as claimed in claim 36, is forced/induced draft fan.

58. The liquid-liquid heat exchanger claimed in claim 36 is made of alternate material such as plastic or any other suitable material compatible with LD.

59. A regenerator/OCD claimed in claim 36 is coupled with a condenser of conventional VCRS.

60. A regenerator/OCD claimed in claim 36 is an adiabatic contacting device with a separate heat exchanger to heat the LD.

61. The optional device as claimed in claim 36, to circulate air through the regenerator/OCD is a chimney.

62. A hybrid cooling system as claimed in claim 36, wherein the elevation difference between the regenerator/OCD and the absorber/ICD is not sufficient, two LD pumps are used to pump the LD, one from the absorber/ICD to regenerator/OCD and the other from the regenerator/OCD to absorber/ICD.

63. A hybrid cooling system as claimed in claim 36, wherein the regenerator/OCD is placed at higher elevation than the absorber/ICD with the LD flowing from regenerator/OCD to absorber/ICD by gravity.

64. A hybrid cooling system as claimed in claim 36, wherein the regenerator/OCD is at a higher elevation than the absorber/ICD, one LD pump is used to pump the LD from the absorber/ICD to regenerator/OCD.

65. A hybrid cooling system as claimed in claim 36, wherein the absorber/ICD is placed at higher elevation than the regenerator/OCD with LD flowing from absorber/ICD to regenerator/OCD by gravity.

66. A hybrid cooling system as in claim 36, wherein the absorber/ICD is at a higher elevation than the regenerator/OCD, one LD pump is used to pump the LD from the absorber/ICD to regenerator/OCD.

67. A hybrid cooling system as in claim 36, wherein the said VCRS is replaced by Vapour Absorption/Adsorption System.

68. Hybrid cooling system as claimed in claim 36, wherein
the pressure ratio across the compressor is reduced up to 36%
cooling effect produced is increased up to 60%
COP increased up to 45%
as compared to VCRS for air conditioning and refrigeration applications involving cooling and/or dehumidification/drying.

69. An adsorption module comprising:
a. a main containment vessel
b. plurality of passages of cross sections that are in thermal contact or integrated into the wall of the containment vessel
c. adsorbent filled in the containment vessel

70. The adsorption module as in claim 69, wherein the cross-section of the containment vessel is circular, square, rectangular, elliptical or any other shape.

71. The adsorption module as claimed in claim 69, wherein the material of construction of the containment vessel is selected from materials such as metals, composite materials preferably with high thermal conductivity of at least 1 W/m.K and being compatible with heat transfer fluids.

72. An adsorption module as claimed in claim 69 wherein the cross section of the passages is circular, square, rectangular, elliptical or any other shape.

73. An adsorption module as claimed in claim 69 wherein the passages are open at both ends allowing through flow of heat transfer fluids.

74. An adsorption module as claimed in claim 69 wherein the number of passages is varied as per the desired rate of heat transfer and fin effectiveness of the module wall.

75. An adsorption module as claimed in claim 69 wherein the containment vessel shell is co-extruded with the passages.

76. An adsorption module as in claim 69 wherein the passages are in thermal contact with the inner surface of the containment vessel wall of the module.

77. An adsorption module as claimed in claim 69 wherein the passages are in thermal contact with the partition(s) in the containment vessel of the module.

78. The adsorption module as in claim 69 wherein the passages run partially along the length of the module.

79. An adsorption module as claimed in claim 69 wherein the passages are optionally non linear.

80. An adsorption module as claimed in claim 69 wherein the sorbents include activated carbon (AC), calcium chloride, magnesium chloride, stronsium chloride, zeolite, silica gel and there like.

81. An adsorption module as claimed in claim 69 wherein the adsorbate include ammonia, methanol, water and alcohols.

82. An adsorption module as claimed in claim 69 wherein the heating is optionally effected by a “non-flow” heat sources such as solar/electric heater and there like.

83. An adsorption module as claimed in claim 69 wherein the “passages” for supplying heat to the module is not necessary when the module directly receives heat through the containment vessel wall and the “passages” are only required to ensure removal of heat from the module.

84. An adsorption module as claimed in claim 69 wherein the “passages” for removal of heat from the module is not necessary when the module directly loses heat through the containment vessel wall and the “passages” are only required to ensure supply of heat to the module.

85. An adsorption module as claimed in claim 69 wherein the passages are closed at one end to function as a heat pipe.

86. Switchable heat pipes comprising.
evaporator
condenser
optional squeezable tube
optional pincher and
means to actuate pincher and/or to displace condenser.

87. Switchable heat pipes as claimed in claim 86 wherein squeezable tube is used to actuate or isolate the heat pipes.

88. Switchable heat pipes as claimed in claim 86 used to transfer heat from a single source to multiple receivers in desired sequence.

89. Switchable heat pipe as claimed in claim 86 used to transfer heat from multiple sources to a single receiver in desired sequence.

90. Switchable heat pipes as claimed in claim 88 wherein tilting of the condenser is used to actuate, control or isolate the heat pipes.

91. Switchable heat pipes as claimed in claim 86 wherein evaporator and condenser forms a continuous “passage” capable of bending enabling control of heat transfer rate and maximum operating temperature of the heat pipe.

92. Switchable heat pipes as claimed in claim 86 wherein heat pipe cross-section is of any shape.

93. Switchable heat pipes as claimed in claim 86 wherein cross section of condenser and evaporator is matched or mismatched.

94. Switchable heat pipes as claimed in claim 86 wherein the material of construction of heat pipe is of any material based on the end use.

95. Switchabe heat pipes as claimed in claim 86, wherein a wick is optionally provided on the inner wall of the evaporator, condenser and squeezable tubing to facilitate the draining back of the fluid.

96. The wick claimed in claim 95 for use in the squeezable tube is selected from material that is also squeezable.

97. Switchable heat pipes as claimed in claim 86 wherein during the adsorption phase when the module needs to be cooled, the cooling heat pipe with its evaporator integrated with the module would be operative, while the heating heat pipe whose evaporator is integrated with the module would be switched off.

98. Switchable heat pipes as claimed in claim 86 wherein means is provided for the isolation of heat pipes where, heat transfer rate is to be varied while exchanging heat between fix temperature source and sink by varying the number of active heat.

99. Switchable heat pipes as claimed in claim 86 capable of being used in refrigeration, airconditioning, waste heat recovery, solar collectors and any application involving heat transfer.

100. A refrigeration cum heating system working on an adsorption refrigeration cycle comprising:
plurality of adsorption modules wherein a plurality of “passages” are in thermal contact with the walls of the containment vessels, so that containment vessel wall acts as fin
“passages”, in thermal contact with the walls of the containment vessel wall act as heat pipes, used for transferring the heat to/from the module
heat recovery tank/heat sink, wherein heat release from the module during the adsorption phase is collected to provide optional hot utility
evaporator
condenser
means for actuating or isolating heat pipes and
heat source such as solar energy, waste heat sources, direct fuel firing.

101. A refrigeration cum heating system as claimed in claim 100 capable of operating with or without hot utility generation.

102. The adsorption module as claimed in claim 100, wherein.
cross-sectional shape of the module is varied based on peak pressures in module and space constraint
number of “passages” for transferring heat to and from the module is varied on the basis of desired capacity of heat pipe,
the “passages” either for heating or cooling is/are optionally eliminated
the material of construction for the module and passages is preferably metallic with high thermal conductivity above 10 W/m.K
the “passages” are in thermal contact with the wall of the main cylinder constructed by co-extrusion, welding, thermal paste or any suitable means.

103. “Passages” of claim 100 are of variable cross-sectional shape and size based on the desired capacity of heat transfer and space constraints.

104. “Passages” of claim 100 are optionally switchable heat pipe(s).

105 Switchable heat pipe(s) claimed in claim 100 optionally uses a pinchable flexible tubing with pinching device for isolating the heat receiving and the heat giving sections.

106. Flexible tube, used in the heat pipes claimed in claim 104 to connect the heat receiving and the heat giving sections, is made of any pinchable/squeezable material that are compatible with the working fluid.

107. A refrigeration system as claimed in claim 100 wherein the number of adsorption modules is varied as per the desired cooling capacity of the system.

108. An adsorption system claimed in claim 100 is optionally operable with adsorption refrigeration cycle with single and multistage pressure equalization for heat regeneration in the adsorption module increasing COP and reducing cycle time.

109. A refrigeration system claimed in claim 100 wherein heat is transferred from heat source to the module and from module to the heat recovery tank/heat sink by means of a switchable heat pipe.

110. A refrigeration system claimed in claim 100 wherein refrigerant is transferred from adsorption module to the condenser and then to the evaporator by simple tube, during generation phase and then returned back by same tube during adsorption phase.

111. A refrigeration system claimed in claim 100 wherein a valve may optionally be used to connect two or more modules for single/multi-stage pressure equalization.

112. A control system used for controlling the flow of heat to and from the adsorption module and flow of refrigerant of claim 100, wherein multiple control is operable using a single control shaft with appropriate cams.

113. The shaft as claimed in claim 101 is operable by a single low rpm motor in the range of 0.2-0.013 rpm.

114. An adsorption module as claimed in claim 69 that
leads to lower cycle times as low as 5 minutes
makes it possible to achieve high system Coefficient of Performance (COP) up to 0.9 due to reduced thermal mass
offers high specific cooling power in the range of 50 to 750 W/kg of AC
is easy to manufacture and operation and costs less.

115. A refrigeration cum heating system as claimed in claim 100 wherein
The heat pipe in thermal contact with the adsorption modules increase the heat transfer rates without increasing the thermal mass leading to increase of COP
The single or multistage pressure equalisation increases the internal regeneration of heat thereby increasing the COP, reducing the cycle time resulting in increased specific cooling power (SCP), reducing the required quantity of adsorbent/refrigerant making the module compact and cost effective.

116. The energy efficient multi-stage regeneration process (EEMSRP) claimed in claim 1 is operated as single stage process wherein there is only a LTR.
